(19) United States
(12) Patent Application Publication
(10) Pub. No.: US 2019/0045965 A1
(43) Pub. Date: Feb. 14, 2019

(54) MODULAR FOOD CARTRIDGES FOR USE IN A COOKING DEVICE

(71) Applicant: Home Tech Innovation, Inc., Cambridge, MA (US)

(72) Inventors: Robin LISS, Cambridge, MA (US); Heather FISHER, Somerville, MA (US)

(73) Assignee: Home Tech Innovation, Inc., Cambridge, MA (US)

(21) Appl. No.: 15/942,860

(22) Filed: Apr. 2, 2018

Related U.S. Application Data
(63) Continuation of application No. 15/487,835, filed on Apr. 14, 2017, now abandoned.
Application No. 15/487,835 is a continuation of application No. PCT/US2017/018312, filed on Feb. 17, 2017.
(60) Provisional application No. 62/296,684, filed on Feb. 18, 2016.

(51) Int. Cl. A47J 27/10; A23L 5/10

(52) U.S. Cl. CPC A47J 27/10; A23L 5/17; A23V 2002/00; A23L 5/13

(57) ABSTRACT

A system includes a first food compartment and a second food compartment configured to be disposed in a first portion and a second portion, respectively, of a fluid immersion device. The first food compartment defines an inner volume and is configured to fluidically isolate a first food item in the inner volume and to transfer thermal energy between a fluid in the first portion of the fluid immersion device and the first food item. The second food compartment is configured to receive a second food item and is at least temporarily coupled to a carrier configured to be disposed in the second food compartment. At least a portion of the second food compartment is fluid permeable and is configured to receive a flow of fluid from the second portion of the fluid immersion device to transfer thermal energy from the fluid to the second food item.

### CROSS-REFERENCE TO RELATED APPLICATIONS

This application is a continuation of International Patent Application Serial No. PCT/US2017/018312 entitled, “Modular Food Cartridges for Use in a Cooking Device,” filed Feb. 17, 2017, which claims priority to and the benefit of U.S. Provisional Patent Application Ser. No. 62/296,684 entitled, “Modular Food Cartridges for Use in a Cooking Device,” filed Feb. 18, 2016, the disclosures of which are incorporated herein by reference in their entireties.

### BACKGROUND

The embodiments described herein relate to apparatus and methods for food packaging and more specifically, to apparatus and methods for packaging and storing food items in a cartridge configured for use in a fluid-immersion cooking device.

Sous-vide is a method of cooking that is intended to maintain the integrity of food by heating the food for an extended period of time at a relatively low temperature. In some instances, a machine can contain a volume of water and can transfer thermal energy to the volume of water to reach and/or maintain a desired temperature thereof. The food in sous-vide cooking methods is disposed in sealed or semi-permeable packages and/or bags, which can be inserted into the machine to submerge the food in the water. Prior to or directly after inserting the food, the water is heated to a temperature typically below the water's boiling point (e.g., around 60 degrees Celsius (° C.) or about 160 degrees Fahrenheit (° F.)). The thermal energy released by the hot water heats the submerged food until a temperature of the food and the temperature of the hot water are in a state of substantial thermal equilibrium. Thus, the food can be cooked to a desired temperature by controlling the temperature of the water in which the food is disposed.

Some known sous-vide cooking methods can involve a significant amount time in preparing the meal, which can, in some instances, present challenges for using sous-vide cooking methods on a daily basis. In an effort to mitigate these challenges, food can be pre-packaged and stored, for example, in a refrigerator. Some such packages, however, fail to contain different food items in a modular cartridge that is configured to allow each food item to be cooked in a different way (e.g., sous-vide, steam, boiling water, etc.) based at least in part on the type of food being cooked (e.g., a meat, a starch, a vegetable, etc.).

Thus, a need exists for apparatus and methods for packaging and storing food items in a cartridge configured for use in a fluid-immersion cooking device that cooks the food in a manner based at least in part on the type of food contained therein.

### SUMMARY

Apparatus and methods for packaging and storing food items in a cartridge configured for use in a fluid-immersion cooking device are described herein. In some embodiments, a system for at least one of storing food items or cooking food items in a fluid immersion device includes a first food compartment, a second food compartment, and a carrier. The first food compartment is configured to be disposed in a first portion of the fluid immersion device. The first food compartment has a set of walls that define an inner volume configured to receive a first food item. The walls are configured to 1) fluidically isolate the first food item in the inner volume and 2) transfer thermal energy between a volume of fluid in the first portion of the fluid immersion device and the first food item. The second food compartment is configured to be disposed in a second portion of the fluid immersion device. The second food compartment has a set of walls defining an inner volume configured to receive a second food item. At least a portion of the walls is fluid permeable and is configured to receive a flow of fluid flowing through the second portion of the fluid immersion device operable in transferring thermal energy from the fluid to the second food item. The carrier is configured to be disposed in the second portion of the fluid immersion device. The carrier has a coupling portion configured to receive the second food compartment to at least temporarily couple the second food compartment to the carrier.

### BRIEF DESCRIPTION OF THE DRAWINGS

FIG. 1 is a schematic illustration of a modular food cartridge according to an embodiment.

FIG. 2 is a perspective view of a storage and/or cooking device configured to receive a modular food cartridge such as those described herein.

FIG. 3 is a perspective view of a modular food cartridge according to an embodiment.

FIG. 4 is a perspective view of a frame included in the module food cartridge illustrated in FIG. 3.

FIGS. 5 and 6 are perspective views of a first member and a second member, respectively, of the frame illustrated in FIG. 4.

FIG. 7 is a partial exploded view of the modular food cartridge illustrated in FIG. 3.

FIGS. 8 and 9 are perspective view of a first food compartment and a second food compartment included in the modular food cartridge of FIG. 3.

FIG. 10 is a perspective view of a modular food cartridge according to an embodiment.

FIG. 11 is a perspective view of a modular food cartridge according to an embodiment.

FIG. 12 is an exploded view of the modular food cartridge of FIG. 11.

FIG. 13 is a cross-sectional view of the modular food cartridge taken along the line 13-13 in FIG. 11.

FIG. 14 is a perspective view of a portion of a modular food cartridge assembly according to an embodiment.

FIG. 15 is a partially exploded perspective view of the portion of the modular food cartridge assembly of FIG. 14.

FIG. 16 is a flowchart illustrating a method of providing food items for use in a fluid immersion device according to an embodiment.

### DETAILED DESCRIPTION

In some embodiments, a system for at least one of storing food items or cooking food items in a fluid immersion device includes a first food compartment, a second food compartment, and a carrier. The first food compartment is configured to be disposed in a first portion of the fluid immersion device. The first food compartment has a set of walls that define an inner volume configured to receive a first food item. The walls are configured to 1) fluidically isolate the first food item in the inner volume and 2) transfer thermal energy between a volume of fluid in the first portion of the fluid immersion device and the first food item. The second food compartment is configured to be disposed in a second portion of the fluid immersion device. The second food compartment has a set of walls defining an inner volume configured to receive a second food item. At least a portion of the walls is fluid permeable and is configured to receive a flow of fluid flowing through the second portion of the fluid immersion device operable in transferring thermal energy from the fluid to the second food item. The carrier is configured to be disposed in the second portion of the fluid immersion device. The carrier has a coupling portion configured to receive the second food compartment to at least temporarily couple the second food compartment to the carrier.

In some embodiments, a system for at least one of storing food items or cooking food items in a fluid immersion device includes a first food compartment configured to receive a first food item, a second food compartment configured to receive a second food item, and a third food compartment configured to receive a third food item. The first food compartment includes an identifier associated with the first food item and is configured to fluidically isolate the first food item therein. The first food compartment is configured to be disposed in a first portion of the fluid immersion device to allow thermal energy to be transferred between the first food item and a volume of fluid in the first portion of the fluid immersion device. The second food compartment includes an identifier associated with the second food item and is configured to be disposed in a second portion of the fluid immersion device. At least a portion of the second food compartment is fluid permeable and is configured to receive a volume of fluid from the second portion of the fluid immersion device operable in transferring thermal energy from the fluid to the second food item. The third food compartment includes an identifier associated with the third food item and is configured to be disposed in the second portion of the fluid immersion device. At least a portion of the third food compartment is fluid permeable and is configured to receive a volume of fluid from the second portion of the fluid immersion device operable in transferring thermal energy from the fluid in the second portion to the third food item.

In some embodiments, a method of providing food items for use in a fluid immersion device includes disposing a first food compartment containing a first food item in a first portion of the fluid immersion device. Data associated with the first food item is provided to the fluid immersion device when the first food compartment is disposed in the first portion of the fluid immersion device. A second food compartment containing a second food item is coupled to a carrier. The carrier is disposed in a second portion of the fluid immersion device after the second food compartment is coupled to the carrier. The second portion of the fluid immersion device is isolated from the first portion of the fluid immersion device. The method includes providing data associated with the second food item to the fluid immersion device when the carrier is disposed in the second portion of the fluid immersion device.

In some embodiments, an apparatus includes a frame defining a notch, a first food compartment, and a second food compartment. The first food compartment has a set of sidewalls that define an inner volume configured to contain a first food item. A portion of the first food compartment is coupled to the frame on a first side of the notch. The sidewalls of the first food compartment are configured to transfer heat energy between a volume outside of the first food compartment and the first food item. The second food compartment has a set of sidewalls that define an inner volume. A portion of the second food compartment is coupled to the frame on a second side of the notch opposite the first side. The inner volume of the second food compartment configured to contain at least a second food item. The second food compartment defines at least one aperture configured to selectively receive a flow of fluid operable to transfer heat energy between at least the second food item and the fluid.

As used in this specification, the singular forms “a,” “an” and “the” include plural referents unless the context clearly dictates otherwise. Thus, for example, the term “a member” is intended to mean a single member or a combination of members, “a material” is intended to mean one or more materials, or a combination thereof.

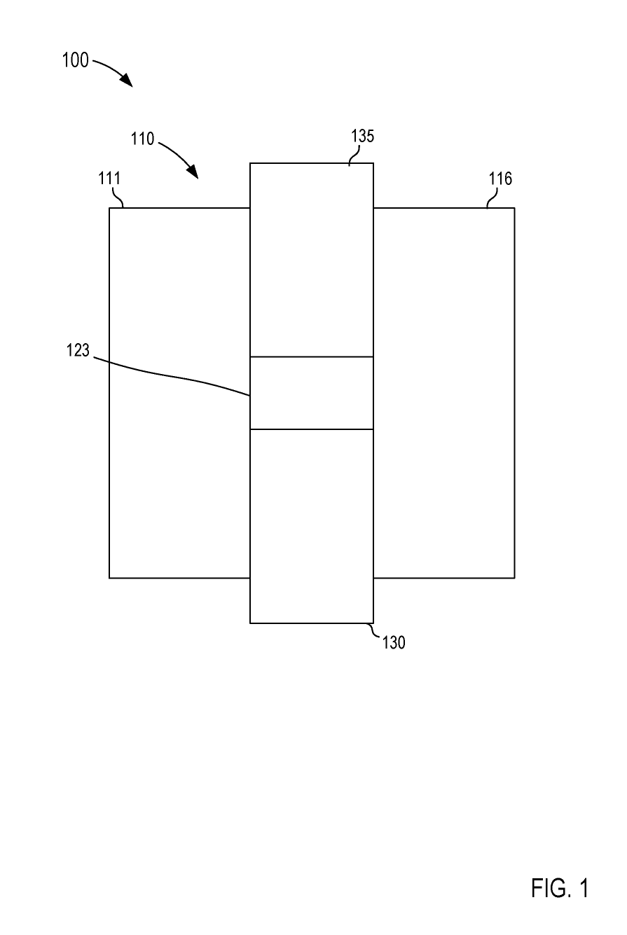

FIG. 1 is a schematic illustration of a modular food cartridge 100 according to an embodiment. The modular food cartridge 100 (also referred to herein as “cartridge”) is configured to contain one or more pre-packaged food items and further configured to be inserted into a cooking device (not shown in FIG. 1). For example, in some embodiments, the cartridge 100 can be inserted into a sous-vide cooking device and/or other suitable fluid immersion cooking or storage device such as those described in U.S. patent application Ser. No. 15/419,627 entitled, “Apparatus and Methods for At Least Semi-Autonomous Meal Storage and Cooking Via Fluid Immersion,” filed Jan. 30, 2017 (referred to henceforth as “the '627 application”), the disclosure of which is incorporated herein by reference in its entirety. Thus, with the cartridge 100 inserted into such a device, the one or more food items contained therein can be stored in a suitable environment (e.g., at a suitable storage temperature) and in response to a change in an operating condition of the device can be cooked at a desired temperature (e.g., at a suitable cooking temperature).

As shown in FIG. 1, the cartridge 100 includes a frame 110, a first food compartment 130, and a second food compartment 135. The frame 110 includes a first member 111 and a second member 116, which collectively form the frame 110 when coupled. For example, in some embodiments, the first member 111 can be coupled to the second member 116 via a snap fit, friction fit, interference fit, an adhesive, ultrasonic welding, mechanical fastener, and/or any other coupling means. In some embodiments, at least a portion of the first food compartment 130 and at least a portion of the second food compartment 135 can be disposed between the first member 111 and the second member 116 prior to coupling the first member 111 and the second member 116 to form the frame 110. In this manner, the first food compartment 130 and the second food compartment 135 couple to the frame 110. In other embodiments, the first food compartment 130 and the second food compartment 135 can be coupled to the first member 111 and/or the second member 116 in any suitable manner such as those described herein. In still other embodiments, the frame 110 can be monolithically constructed (e.g., can be a single piece) and unitarily formed with the first food compartment 130 and/or the second food compartment.

The frame 110 can have any suitable shape, size, and/or configuration. For example, in some embodiments, the size and/or shape of the frame 110 can be based at least in part on a storage and cooking device into which the cartridge 100 is to be inserted. In the embodiment shown in FIG. 1, the frame 110 defines a notch 123. In other words, the first member 111 and the second member 116 collectively form and/or define the notch 123 when coupled. In some embodiments, the notch 123 can be associated with a portion of the storage and/or cooking device into which the cartridge 100 is to be inserted. For example, in some embodiments, the notch 123 can engage and/or receive a predetermined portion of the storage and/or cooking device when the cartridge 100 is disposed therein. In such embodiments, this arrangement can align and/or position the cartridge 100 within the storage and/or cooking device. Moreover, the arrangement of the cartridge 100 is such that the first food compartment 130 is coupled to the frame 110 on a first side of the notch 123 and the second food compartment 135 is coupled to the frame 110 on a second side of the notch 123 opposite the first side. In this manner, when the cartridge 100 is disposed in the storage and/or cooking device, the first food compartment 130 and the second food compartment 135 can be disposed in predetermined portions of the storage and/or cooking device, as described in further detail herein.

The first food compartment 130 and the second food compartment 135 each are configured to at least temporarily contain and/or house one or more food items. As described above, the cartridge 100 can be configured for use within a fluid immersion storage and/or cooking device such as those described in the '627 application incorporated by reference above. Thus, the first food compartment 130 and the second food compartment 135 are configured to be disposed in a portion of the fluid immersion storage and/or cooking device that places the food compartments 130 and 135 in contact with a flow of a cooling or heating fluid. In some embodiments, the food compartments 130 and 135 can be configured to be submerged in a fluid and/or can be configured to selectively receive a flow of a fluid therethrough. In this manner, the arrangement of the first food compartment 130 and the second food compartment 135 is such that when the cartridge 100 is positioned within a storage and/or cooking device, thermal energy can be transferred between one or more food items disposed within the food compartments 130 and/or 135 and an environment substantially outside of the food compartments 130 and/or 135.

Although not shown in FIG. 1, the first food compartment 130 and the second food compartment 135 each include and/or are at least temporarily coupled to a removable seal or cover configured to provide access to the inner volume of the first food compartment 130 and second food compartment 135, respectively. For example, in some embodiments, a removable seal or cover can be at least temporarily coupled to each of the food compartments 130 and 135 via an adhesive. In other embodiments, the seal or cover can be coupled to each of the food compartments 130 and 135 and can have a removable portion partially circumscribed by perforations or the like. In still other embodiments, the inner volume of each of the food compartments 130 and 135 can be accessed by cutting, tearing, puncturing, and/or otherwise deforming such a seal or cover.

The first food compartment 130 and the second food compartment 135 can be any suitable shape, size, and/or configuration. In some embodiments, the first food compartment 130 and the second food compartment 135 can be substantially similar. In other embodiments, the first food compartment 130 can have a first configuration and the second food compartment 135 can have a second configuration different from the first configuration. In some embodiments, the configuration of the first food compartment 130 and the second food compartment 135 can each be based at least in part on a type of food contained therein.

For example, in some embodiments, the first food compartment 130 can be a flexible, fluid impermeable pouch, bag, package, and/or the like. The first food compartment 130 defines an inner volume configured to contain one or more food items such as, for example, a meat or other protein. During a packaging process or the like, one or more food items can be disposed in the inner volume of the first food compartment 130, which can then be at least partially vacuum-sealed. The first food compartment 130 can be formed from a thermally conductive material configured to transfer thermal energy between a volume outside of the first food compartment 130 and the one or more food items disposed therein. For example, as described above, the cartridge 100 can be inserted into a storage and/or cooking device such as those described in the '627 application, which can circulate a fluid around the first food compartment 130 (e.g., the first food compartment 130 is at least partially submerged in the fluid) to transfer thermal energy therebetween, as described in further detail herein.

In some embodiments, the second food compartment 135 can be formed of a substantially rigid material having a predetermined shape and size. The second food compartment 135 defines an inner volume configured to contain one or more food items such as, for example, a starch, vegetable, and/or a combination thereof. In some embodiments, the second food compartment 135 can include a divider that divides the inner volume into a first portion configured to receive a first type of food item (e.g., a starch) and a second portion configured to receive a second type of food item (e.g., vegetable). In some embodiments, the second food compartment 135 can be configured to selectively place the inner volume of the second food compartment 135 in fluid communication with a flow of fluid circulating through a portion of a storage and/or cooking device such as those described in the '627 application incorporated by reference above. For example, in some embodiments, the second food compartment 135 can include one or more ports (e.g., septa, valves, manifolds, frangible portions, etc.) configured to place the inner volume of the second food compartment 135 in selective fluid communication with a volume outside of the second food compartment 135. In such embodiments, the one or more ports can fluidically isolate the inner volume of the second food compartment 135 prior to inserting the cartridge 100 into a storage and/or cooking device. Thus, in some embodiments, second food compartment 135 can be configured to selective receive a flow of fluid to transfer thermal energy between one or more food items disposed therein and the fluid, as described in further detail herein.

While the first food compartment 130 is described as a flexible pouch or the like configured to contain, for example, a meat or other protein and the second food compartment 135 is described above as a substantially rigid container configured to contain, for example, a starch, vegetable, or a combination thereof, it is to be understood that the first food compartment 130 and the second food compartment 135 can have any suitable shape, size, and/or configuration. In some embodiments, for example, both of the food compartments 130 and 135 can be a flexible pouch or, in other embodiments, both can be a substantially rigid container. Similarly, the first food compartment 130 and/or the second food compartment 135 can contain one or more food items of any suitable type or combination of types (e.g., meats, starches, vegetables, etc.). In some embodiments, the food compartments 130 and 135 can include the same type of food items.

Although not shown in FIG. 1, the first food compartment 130 and/or the second food compartment 135 can include a ferromagnetic element or the like that can be energized via induction to transfer thermal energy to one or more food items contained therein. For example, in some embodiments, the first food compartment 130 and/or the second food compartment 135 can include a plate, wire, and/or portion formed of the ferromagnetic material. In such embodiments, the magnetic field induced in the ferromagnetic material heats the material and thus, the material can transfer thermal energy to the one or more food items. In some instances, such an arrangement can be used, for example, to sear meat contained in the first food compartment 130.

While not shown in FIG. 1, in some embodiments, the first food compartment 130 and/or the second food compartment 135 can include and/or can be formed of a selectively absorbent material configured to absorb excess fluids within the inner volumes of the food compartments 130 and/or 135 (e.g., during cooking). For example, in some embodiments, an absorbent pad or the like can be disposed within the first food compartment 130 and configured to absorb fluid released from meat or protein being cooked therein. In some embodiments, the absorbent material can be impregnated with a concentrated sauce or the like (or can contain a powder or paste) that can be reconstituted or otherwise diluted by the fluid released from the food (e.g., meat) and subsequently released from the absorbent material. In such embodiments, the amount and/or concentration of the sauce or the like can be based on a predetermined, estimated, and/or anticipated amount of fluid released from the food (e.g., meat). In other embodiments, the first food compartment 130 and/or the second food compartment 135 can contain a concentrated sauce, powder, paste, etc. without an absorbent member, which can similarly be reconstituted and/or diluted by the fluid released from the food and/or a fluid otherwise circulating therethrough.

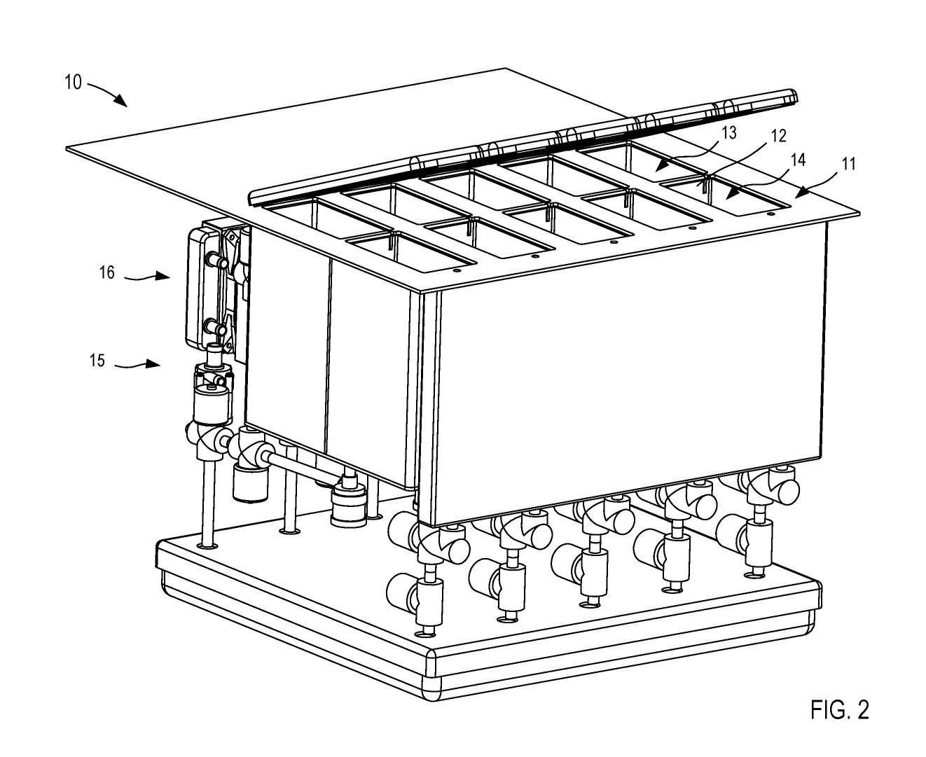

As described above, the cartridges described herein are configured to contain one or more food items and further configured to be inserted into any suitable storage and/or cooking device. By way of example, FIG. 2 illustrates a storage and/or cooking device 10 configured to receive any of the cartridges described herein. The storage and/or cooking device 10 (also referred to herein as “device”) can be any suitable device such as, for example, a device configured to transfer thermal energy via a circulating fluid (or via fluid immersion). In some embodiments, for example, the device 10 can be similar to or substantially the same as those described in the '627 application incorporated by reference above. It should be understood that the cartridges and/or embodiments described herein are not limited to use in the device 10; rather, the device 10 particularly shown and described herein with reference to FIG. 2 is presented by way of example to provide context where needed. While portions of the device 10 are described below, the discussion of the device 10 is not exhaustive; rather, the discussion below provides a reference to the relevant features thereof to provide context for the detailed discussion of the embodiments (i.e., cartridges) described herein.

As shown in FIG. 2, the device 10 includes a set of thermal containers 11. Each thermal container 11 includes a first portion 13 (or volume) and a second portion 14 (or volume), which are separated by a divider 12. In some embodiments, the first portion 13 can be configured to receive a first portion of a modular food cartridge that contains, for example, a first kind of food (e.g., meats and/or other proteins) and the second portion 14 can be configured to receive a second portion of the modular food cartridge that contains, for example, a second kind of food (e.g., vegetables, starches, carbohydrates, and/or the like). In some embodiments, the food cartridges such as those described herein and the thermal container 11 are collectively arranged or configured (e.g., via any suitable alignment feature) such that a food cartridge can be disposed in one orientation within the thermal container 11 such that the first kind of food is disposed in the first portion 13 and the second kind of food is disposed in the second portion 14.

The device 10 further includes a circulation system 15 configured to circulate a fluid through the first portion 13 and/or the second portion 14 of each thermal container 11. The device 10, for example, can include any suitable flow devices such as pumps, valves, conduits, ports, etc. configured to direct a flow of fluid through the device 10. Moreover, the device 10 include a heat transfer system 16 that is configured to transfer thermal energy from the circulating fluid when the device 10 is in a storage configuration and to transfer thermal energy to the circulating fluid when the device 10 is in a cooking configuration. For example, the heat transfer system 16 can include any suitable heat exchanger, heating element, thermoelectric heating and/or cooling device, etc. Thus, the cartridges described herein can contain any suitable food items that can be stored at a suitable storage temperature or cooked at a suitable cooking temperature when the cartridge(s) are disposed in the device 10.

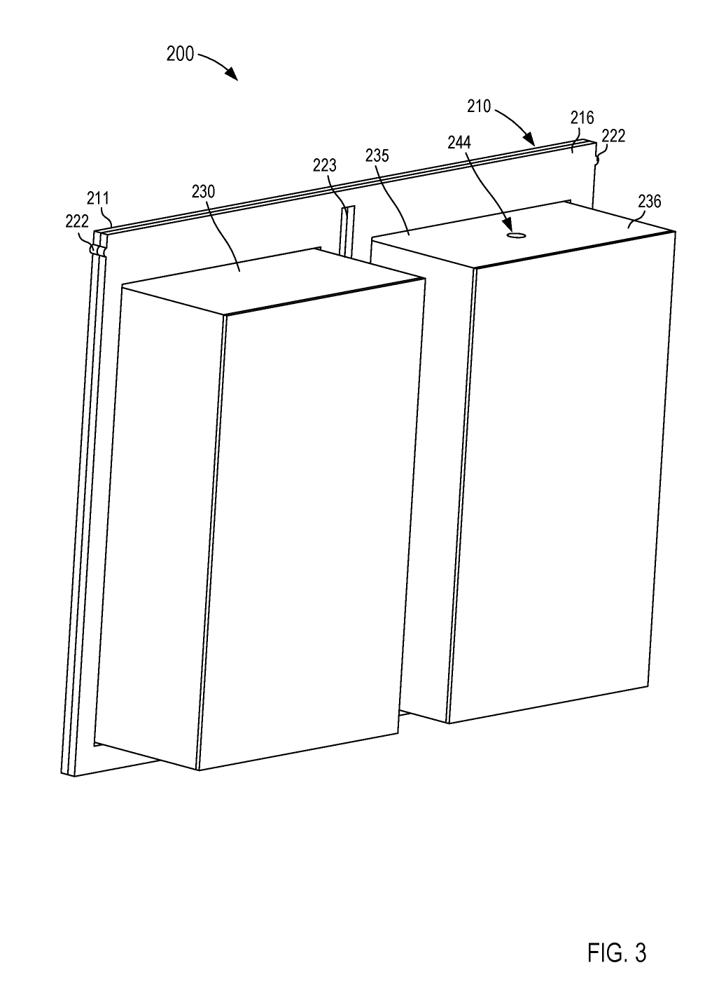

FIGS. 3-9 illustrate a modular food cartridge 200 according to an embodiment. The modular food cartridge 200 (also referred to herein as “cartridge”) is configured to contain one or more pre-packaged food items and further configured to be inserted into a storage and/or cooking device such as the device 10 shown in FIG. 2. Thus, when the cartridge 200 is inserted into the device 10, the one or more food items contained in cartridge 200 can be stored in a suitable environment (e.g., at a suitable storage temperature) and in response to a change in an operating condition of the device 10 can be cooked at and/or to a desired temperature (e.g., at a suitable cooking temperature).

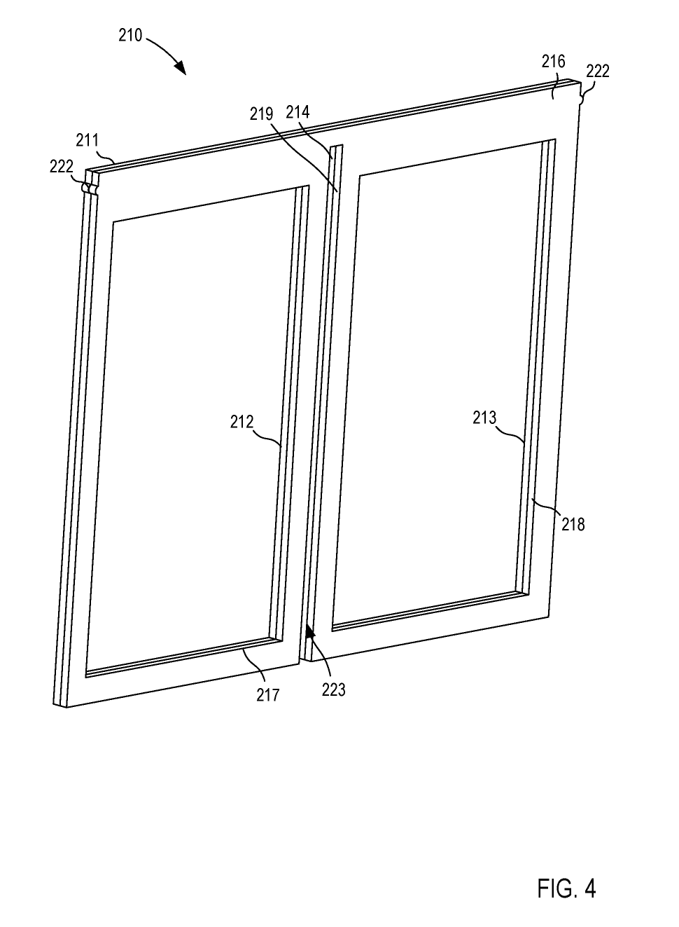

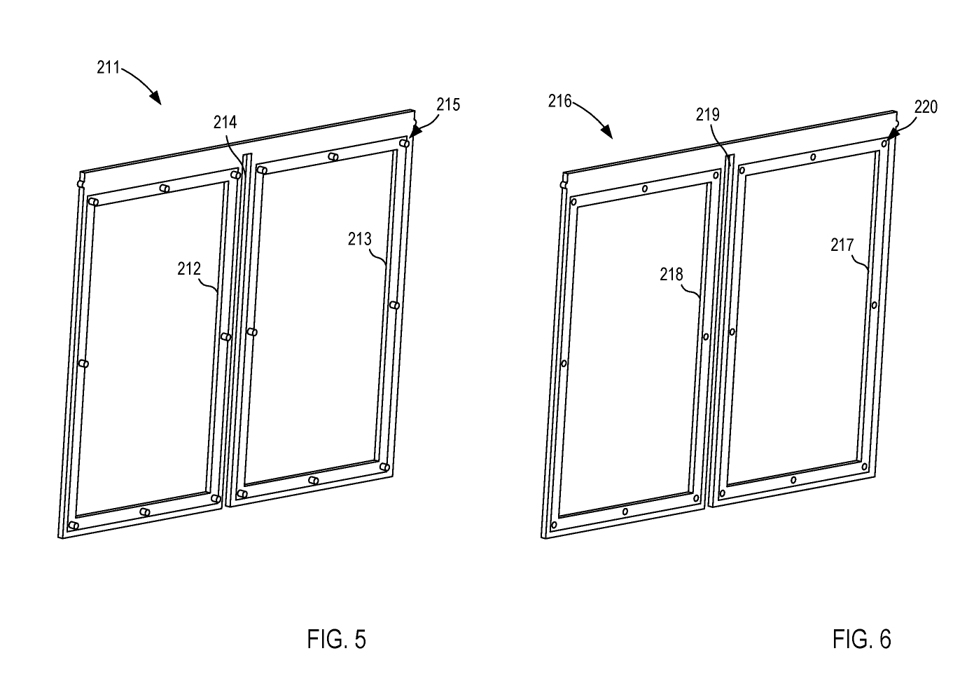

The cartridge 200 includes a frame 210, a first food compartment 230, and a second food compartment 235, as shown in FIG. 3. In this embodiment, the frame 210 includes a first member 211 and a second member 216. The first member 211 and the second member 216 are substantially similar and are coupled to collectively form the frame 210 (see e.g., FIGS. 3 and 4). As shown in FIGS. 4-6, the first member 211 of the frame 210 includes a set of couplers 215 and defines a first opening 212, a second opening 213, and a notch 214 (FIG. 5). Similarly, the second member 216 of the frame 210 includes a set of couplers 220 and defines a first opening 217, a second opening 218, and a notch 219 (FIG. 6). With the first member 211 and the second member 216 of the frame 210 being substantially similar, the features of the first member 211 are aligned with the corresponding features of the second member 216 when coupled thereto. Specifically, the first opening 212, the second opening 213, and the notch 214 of the first member 211 are substantially aligned with the first opening 217, the second opening 218, and the notch 219, respectively, of the second member 216 when the first member 211 is coupled thereto, as shown in FIG. 4.

In this embodiment, the couplers 215 of the first member 211 are configured to engage the couplers 220 of the second member 216 to couple the first member 211 and second member 216. For example, in some embodiments, each of the couplers 215 of the first member 211 can be a protrusion, snap, post, etc. and each of the couplers 220 of the second member 220 can be an opening, snap, receptacle, etc. Thus, the couplers 215 and 220 can collectively form a snap fit, friction fit, interference fit, and/or other suitable mechanical fastening operable to coupling the first member 211 and the second member 216. In other embodiments, the first member 211 and the second member 216 can be coupled by any suitable coupling method such as, for example, an adhesive, an ultrasonic weld, a tab and slot arrangement, and/or the like. In some embodiments, the first member 211 is permanently coupled to the second member 216. In other embodiments, the first member 211 is removably coupled to the second member 216. Moreover, in some embodiments, at least a portion of the first food compartment 230 and at least a portion of the second food compartment 235 can be disposed between the first member 211 and the second member 216, thereby coupling the first food compartment 230 and the second food compartment 235 to the frame 210, as described in further detail herein.

While the first member 211 and the second member 216 are described above as collectively forming the frame 210 when coupled, in other embodiments, at least a portion of the frame 210 can be monolithically constructed from a single piece or member. For example, in some embodiments, a frame having substantially the same size and/or shape as the frame 210 can be a monolithically formed piece. In some such embodiments, the frame can be formed, for example, via injection molding or the like. Moreover, in some embodiments, the frame can be monolithically formed with a first food compartment and/or a second food compartment (e.g., similar to the first food compartment 230 and/or the second food compartment 235, respectively). For example, in some embodiments, the frame 210 can be a monolithically constructed frame that is unitarily formed with the second food compartment 235. For example, in some embodiments, the frame 210 and the second food compartment 235 can have a monolithic construction, formed via injection molding. In such embodiments, the first food compartment 230 can be formed independent of the frame 210 and coupled thereto via any suitable manner (e.g., an adhesive, ultrasonic welding, one or more mechanical fasteners, etc.). In this manner, the first food compartment 230 can be formed from, for example, a different material than the frame 210 and/or the second food compartment 230. In still other embodiments, the frame 210 and the first food compartment 230 can be co-molded or the like.

The frame 210 can have any suitable shape, size, and/or configuration. For example, in some embodiments, the frame 210 has a size and/or shape that is based at least in part on a storage and cooking device into which the cartridge 200 is to be inserted. More specifically, in this embodiment, the notch 214 of the first member 211 and the notch 219 of the second member 216 (referred to collectively as the notch 223 of the frame 210, as shown in FIG. 4) are associated with the divider 12 of the device 10. In this manner, the notch 223 of the frame 210 can be disposed about, can receive, and/or otherwise can engage the divider 12 when the cartridge 200 is inserted into the device 10. In some embodiments, the divider 12 can define an alignment notch and/or other suitable feature that engages a portion of the frame 210 to locate, align, and/or position, the cartridge 200 within the thermal container 11 of the device 10. This arrangement can allow the cartridge 200 to be inserted into and disposed within the device 10 in a single orientation (e.g., a predetermined orientation) such that the first food compartment 230 and the second food compartment are placed in desired positions within the thermal container 11, as described in further detail herein.

As shown in FIG. 4, the first member 211 and the second member 212 collectively form engagement protrusions 222 that extend from frame 210 (e.g., from opposite sides of the frame 210). The engagement protrusions 222 are configured to contact the thermal container 11 and/or other portion of the device 10 when the cartridge 200 is inserted into the thermal container 11 to produce a haptic and/or audible indication associated with the cartridge 200 being placed in a desired position within the device 10. For example, this arrangement can be such that the cartridge 200 is “snapped” into place when the cartridge 200 is fully inserted into the thermal container 11. In some embodiments, the “snapping” of the cartridge 200 into place can produce, for example, an audible indication such as, for example, a click or the like that can indicate to a user that the cartridge 200 has been correctly inserted into the thermal container 11 and placed in the desired position. Although the frame 210 is shown and described as having engagement protrusions 222 on opposite sides thereof, in other embodiments, the frame 210 can include a single engagement protrusion 222 disposed on one side of the frame 210 or multiple engagement protrusions 222 formed on any suitable portion of the frame 210 and/or cartridge 200.

Although not shown in FIGS. 3-9, in some embodiments, the frame 210 can include any suitable identification tag, code, and/or device that is associated with data relating to the one or more food items contained in the cartridge 200. For example, in some embodiments, the frame 210 can include a barcode, a quick response (QR) code, a near field communication (NFC) device or radio, a radio frequency identification (RFID) device or radio, and/or the like. In some embodiments, such a tag, code, and/or device can be, for example, embedded in the frame 210, printed on the frame 210, and/or otherwise coupled to the frame 210. In such embodiments, the device 10 can include a corresponding scanner, reader, and/or transceiver configured to scan the code on the frame 210 (e.g., bar or QR code) and/or otherwise receive a signal from an electronic identification device or radio (e.g., NFC or RFID device or radio). Thus, based on the scan and/or signal, the device 10 can determine and/or reference data associated with the cartridge 200 (e.g., data associated with the food contained in the cartridge 200, storing and/or cooking instructions, times, temperatures, expiration dates, and/or any other suitable information).

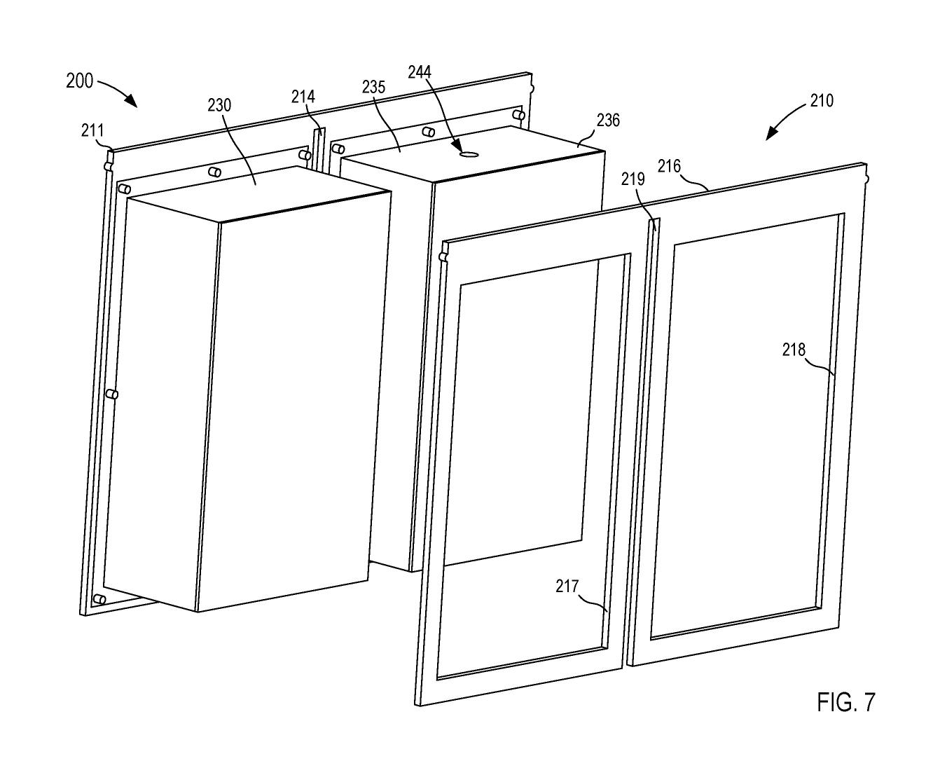

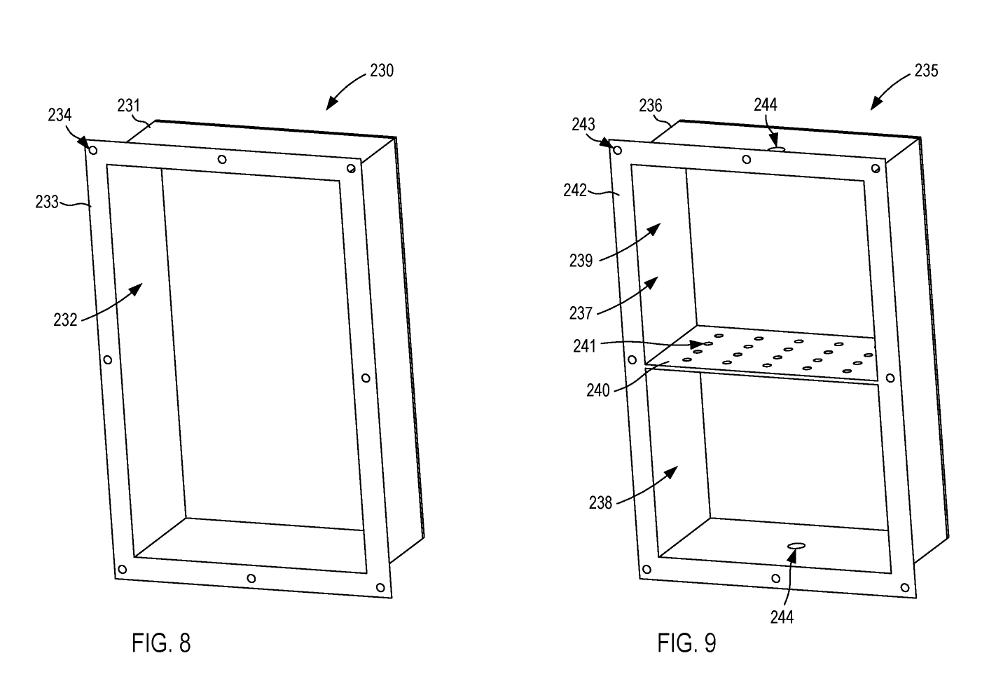

As described above, the cartridge 200 includes the first food compartment 230 and the second food compartment 235 that are configured to at least temporarily contain and/or house one or more food items. The first food compartment 230 and the second food compartment 235 can be any suitable shape, size, and/or configuration. For example, as shown in FIGS. 7 and 8, the first food compartment 230 includes a set of sidewalls 231 and a flange 233. The sidewalls 231 collectively define an inner volume 232 configured to contain one or more food items such as, for example, a meat or other protein, as described in further detail herein.

While the first food compartment 230 is shown, for example, as being a box or package having a fixed, substantially rectangular shape, the first food compartment 230 can be formed of any suitable material and can have any suitable shape. For example, in some embodiments, the first food compartment 230 can be a flexible pouch, bag, package, and/or the like. In such embodiments, the flexible pouch or the like can have an amorphous shape (e.g., having a shape based on, for example, its contents, rather than a predetermined shape). In some embodiments, one or more food items can be disposed in the inner volume 232 of the first food compartment 230 during a processing or packaging process and once the food item(s) are disposed therein, the first food compartment 230 can be at least partially vacuum-sealed.

In this embodiment, the first food compartment 230 is formed of a material that is fluid impermeable and thermally conductive. For example, with the cartridge 200 configured for use in the device 10 or other suitable fluid immersion storage and/or cooking device, forming the first food compartment 230 from a fluid impermeable material is such that the one or more food items disposed in the inner volume 232 of the first food compartment 230 are fluidically isolated from the fluid flowing through the device 10. Conversely, by forming the first food compartment 230 of a thermally conductive material, the one or more food items disposed in the inner volume 232 of the first food compartment 230 are placed in thermal communication with the fluid flowing through the device 10, thereby allowing heat transfer between the one or more food items and the fluid.

While the first food compartment 230 is described as being formed of a thermally conductive material, in some embodiments, the first food compartment 230 can also include a ferromagnetic element or the like that can be energized via induction to transfer thermal energy to one or more food items contained therein. For example, in some embodiments, the first food compartment 230 can include a plate, wire, and/or portion formed of a stainless steel or other ferromagnetic material. In such embodiments, the device 10 can induce a magnetic field in the material (stainless steel or other ferromagnetic material) resulting in a generation of heat therein. Thus, the material can transfer thermal energy to the one or more food items in response to an applied magnetic field (i.e., via induction cooking). In some instances, such an arrangement can be used, for example, to sear a food item (e.g., meat or protein) contained in the first food compartment 230. Moreover, because the material is energized via magnetic induction, the temperature of the material due to the induction can be accurately and/or precisely controlled while the remaining portions of the first food compartment 230 (e.g., formed of a plastic or non-ferromagnetic material) are substantially unaffected.

As described above, a portion of the first food compartment 230 is disposed between the first member 211 and the second member 216 of the frame 210 to couple the first food compartment 230 thereto. More specifically, the first food compartment 230 can be positioned relative to the first member 211 such that the inner volume 232 of the first food compartment 230 is substantially aligned with the first opening 212 defined by the first member 211. That is to say, the first food compartment 230 can be aligned with a portion of the first member 211 on a first side of the notch 214 defined by the first member 211. As shown in FIG. 7, the flange 233 can be placed in contact with a surface of the first member 211 such that the couplers 215 of the first member 211 extend through a set of openings 234 defined by the flange 233. Thus, the flange 233 is maintained in a substantially fixed position when the second member 216 is coupled to the first member 211, which in turn, couples the first food compartment 230 to the frame 210. Moreover, a portion of the first food compartment 230 extends through the first opening 217 defined by the second member 216 when the second member 216 is coupled to the first member 211 (see e.g., FIG. 3).

While the flange 233 is described above as defining the set of openings 234 that receive the couplers 215 of the first member 211, in other embodiments, the flange 233 need not define a set of openings. For example, in some embodiments, the flange 233 of the first food compartment 230 can be positioned between the first member 211 and the second member 216 such that the coupling of the first member 211 to the second member 216 clamps the first food compartment 230 therebetween without the couplers 215 extending through the flange 233 (e.g., through the openings 234 otherwise defined by the flange 233). In still other embodiments, the first food compartment 230 can be monolithically formed with and/or fixedly coupled to the first member 211 and/or the second member 216.

The arrangement of the cartridge 200 is such that the first food compartment 230 is disposed on a first side of the notch 223 defined by the frame 210. With the cartridge 200 configured to be disposed in the device 10 in a predetermined orientation, coupling the first food compartment 230 to the frame 210 on the first side of the notch 223 is such that the first food compartment 230 is placed in the first portion 213 of the thermal container 211 when the cartridge 200 is disposed in the device 10. For example, in some embodiments, the first food compartment 230 is configured to contain one or more food items of a given type such as, for example, meat and/or other protein. Thus, the arrangement of the first food compartment 230 is based at least in part on the food type contained therein (e.g., meat and/or other protein). Expanding further, arranging the first food compartment 230 for use with a given food type and positioning the cartridge 200 in a single, predetermined orientation when disposed in the thermal container 11 of the device 10, can allow one or more food items contained in the first food compartment 230 to be stored and/or cooked in a first method while one or more food items contained in the second food compartment 235 are stored and/or cooked in a second method, as described in further detail herein.

Although not shown in FIGS. 7 and 8, in some embodiments, the first food compartment 230 can include an absorbent member disposed in the inner volume 232. The absorbent member can be configured to absorb moisture released by the one or more food items during cooking, or can be configured to release a fluid during cooking of the one or more food items contained therein. The absorbent member can be any suitable member configured to absorb fluids. In some embodiments, for example, an absorbent member can be a pad formed of first outer layer formed of a porous polyethylene (PE) material, an inner layer formed of cellulose or a super absorbent polymer, and a second outer layer formed of a non-porous PE material. In some embodiments, the absorbent member can be substantially similar to know absorbent members commonly used in meat packaging or the like. For example, as described above, the first food compartment 230 is configured to contain a meat and/or other protein, which can release a fluid (e.g., water, blood, and/or liquid tissue particles) when cooked. Thus, the absorbent member can be disposed in the first food compartment 230 along with the meat to absorb the fluid released by the meat during cooking.

In other embodiments, for example, the absorbent member can be impregnated with a condensed fluid, paste, etc. prior to being disposed in the first food compartment 230. Similarly, the absorbent member and/or other fluid permeable pouch can include dry seasoning, powder, spices, etc. As such, when the meat or protein in the first food compartment 230 is cooked, the fluid (e.g., water, blood, or “juice”) released by the meat or protein can reconstitute and/or otherwise dilute the concentrated fluid, paste, seasoning, etc. contained in the absorbent member. For example, in some embodiments, the condensed fluid or paste can be a condensed sauce, flavoring, seasoning, marinade, and/or the like that is reconstituted and/or diluted by the fluid (e.g., juices) released by the meat or protein. In such embodiments, the amount and/or concentration of the condensed fluid or paste can be based on a predetermined, estimated, and/or anticipated amount of fluid that will be released from the meat or protein during cooking. By way of example, in some instances, it may be desirable to have four Tablespoons of sauce after cooking a meat or protein contained in the first food compartment 230 and it can be determined, based on the type and/or amount of meat or protein, that three Tablespoons of fluid will be released from the food during cooking. Thus, the first food compartment 230 can include an absorbent member containing one Tablespoon of a condensed fluid, paste, etc., which in turn, will be reconstituted and/or diluted by the fluid released by the food to produce the four Tablespoons of the sauce having the desired concentration.

In some embodiments, the arrangement of the absorbent member can be such that as the condensed fluid or paste is reconstituted or diluted to a desired extent, the sauce or the like (having the desired concentration and/or consistency) is released from the absorbent member. In other embodiments, the condensed fluid or paste can be reconstituted and/or diluted and retained in the absorbent member. In some such embodiments, after cooking and after removing the cartridge 200 from the device 10, a user can remove and “plate” (position the food on a dinner plate, etc.) the meat or protein. In addition, the user can remove the absorbent member from the first food compartment 230 and can manipulate the absorbent member, for example, to release the reconstituted and/or diluted sauce or the like on or with the plated meat or protein. While the condensed fluid, paste, and/or powder is described above as being disposed and/or contained in an absorbent member, in other embodiments, the first food compartment 230 can include a condensed fluid, paste, or powder configured to be reconstituted and/or diluted by a fluid released from the food, which is not disposed in an absorbent member or other fluid permeable pouch.

Although not shown, the first food compartment 230 includes and/or is at least temporarily coupled to a removable seal or cover configured to provide access to the inner volume 232 of the first food compartment 230. For example, in some embodiments, a removable seal or cover can be at least temporarily coupled to flange 233 of the first food compartment 230 and 235 via an adhesive. In such embodiments, at least a portion of the seal and/or cover can be accessed via, for example, the first opening 212 defined by the first member 211. In other embodiments, a sidewall 231 of the first food compartment 230 can form and/or can include the seal and/or cover. In some embodiments, the seal or cover can have a removable portion partially circumscribed by perforations, thereby allowing a user to peel or tear away a portion of the seal or cover from the first food compartment. In still other embodiments, the first food compartment 230 need not include a seal and/or cover and, as such, access to the inner volume 232 can be gained by cutting, tearing, puncturing, and/or otherwise deforming one or more sidewalls 231.

While the first food compartment 230 is described above as being formed of a flexible material, the second food compartment 235 can be formed of a substantially rigid material (e.g., a relatively hard plastic or the like) having a predetermined shape and size. In some embodiments, the second food compartment 235 can be formed of a material that is fluid impermeable and thermally conductive. In other embodiments, the second food compartment 235 can be formed from a thermally insulating material configured to thermally insulate a volume within the second food compartment 235 from a volume outside of the second food compartment.

As shown in FIGS. 7 and 9, the second food compartment 235 includes a set of sidewalls 236, a divider 240, and a flange 242. The sidewalls 236 collectively define an inner volume 237 having a first portion 238 and a second portion 239. In some embodiments, the first portion of 238 of the inner volume 237 is configured to contain one or more food items of a first type such as, for example, a starch or the like, and the second portion 239 of the inner volume 237 is configured to contain one or more food items of a second type such as, for example, a vegetable. In other embodiments, the first portion 238 and the second portion 239 of the inner volume 237 can be configured to contain food items of a similar type. In still other embodiments, the inner volume 237 can be a single contiguous volume configured to container one or more food items of a similar type or a different type. Although not shown in FIGS. 7 and 9, in some embodiments, the one or more food items contained in the first portion 238 and/or the second portion 239 can be disposed in fluid permeable bag, pouch, container, etc. For example, in some embodiments, the first portion 238 of the inner volume 237 can contain a starch such as rice. In such embodiments, the rice can be contained in a fluid permeable bag configured to allow the rice to be handled as a single bulk item while still placing the rice in fluid communication with a fluid operable to cook the rice. In some embodiments, such an arrangement can, for example, simplify one or more packaging processes, handling process, and/or the like.

Although not shown, the second food compartment 235 includes and/or is at least temporarily coupled to a removable seal or cover configured to provide access to the inner volume 237 of the second food compartment 235. For example, in some embodiments, a removable seal or cover can be substantially similar to the removable seal and/or cover described above with reference to the first food compartment 230. In some embodiments, the seal and/or cover of the first food compartment 230 can be disposed on a side of the first food compartment 230 adjacent to the frame 210 and the seal and/or cover of the second food compartment 230 can be disposed on a side of the second food compartment 235 opposite the frame 210.

As described above with reference to the first food compartment 230, the flange 242 of the second food compartment 235 is disposed between the first member 211 and the second member 216 of the frame 210 and couples the second food compartment 235 thereto. For example, as shown in FIG. 7, the flange 242 can be placed in contact with a surface of the first member 211 such that the couplers 215 of the first member 211 extend through a set of openings 243 defined by the flange 242. Thus, the flange 233 is maintained in a substantially fixed position when the second member 216 is coupled to the first member 211, which in turn, couples the second food compartment 235 to the frame 210. Moreover, a portion of the second food compartment 235 extends through the second opening 218 defined by the second member 216 when the second member 216 is coupled to the first member 211 (see e.g., FIG. 3).

The arrangement of the cartridge 200 is such that the second food compartment 235 is disposed on a second side of the notch 223 defined by the frame 210. As described above with reference to the first food compartment 230, coupling the second food compartment 235 to the frame 210 on the second side of the notch 223 is such that the second food compartment 235 is placed in the second portion 14 of the thermal container 11 when the cartridge 200 is disposed in the device 10. For example, in some embodiments, the second food compartment 235 is configured to contain one or more food items of a given type such as, for example, starches and/or vegetables. Thus, as described above with reference to the first food compartment 230, the one or more food items contained in the first food compartment 230 can be stored and/or cooked in the first method while the one or more food items contained in the second food compartment 235 are stored and/or cooked in the second method, as described in further detail herein.

As shown in FIG. 9, the sidewalls 236 define and/or include a set of ports 244 configured to establish selective fluid communication between a portion of the device 10 and the inner volume 237 of the second food compartment 235. Similarly, the divider 240 defines one or more openings 241 each of which is configured to establish selective fluid communication between the first portion 238 of the inner volume 237 and the second portion 239 of the inner volume 237. The ports 244 can be any suitable configuration and disposed in any suitable arrangement. For example, in this embodiment, the sidewalls 236 define and/or include a bottom port 244 and a top port 244 (opposite the bottom port 244). The ports 244 can be, for example, openings, holes, valves, piercable membranes, septa, diaphragms, frangible members, and/or the like. In some embodiments, for example, the ports 244 can be openings including an O-ring or the like. In some embodiments, such openings can be temporarily covered by a removable film, cap, cover, etc.

The arrangement of the second food compartment 235 is such that the ports 244 are aligned with a port, outlet, inlet, conduit, tubing, puncture member, etc. of the device 10 when the cartridge 200 is inserted into the thermal container 11 in the single, predetermined orientation, thereby establishing fluid communication between the second food compartment 235 and the device 10. For example, in some embodiments, a conduit or the like can be inserted through the ports 244 when the cartridge 200 is positioned in the thermal container 11. In such embodiments, the device 10 and/or the second food compartment 235 can include an O-ring or the like configured to form a substantially fluid-tight seal, thereby sealing an interface between the second food compartment 235 and the device 10. In other embodiments, a puncture member or the like of the device 10 can pierce or puncture the ports 244 (e.g., septa, membranes, frangible members, etc.) to establish fluid communication between the inner volume 237 of the second food compartment 235 and the device 10. In still other embodiments, the ports 244 can be fluid and/or temperature activated valves, membranes, septa, etc. configured to transition from a closed configuration to an open configuration in response to contact with a fluid and/or in response to a predetermined temperature being reached. In this manner, the inner volume 237 of the second food compartment 235 can selectively receive a flow of fluid that can be operable to transfer thermal energy to or from the one or more food items disposed therein. More specifically, as shown in FIG. 9, the second food compartment 244 can define a bottom port 244 configured to be placed in fluid communication with the device 10 to transfer an inlet flow of fluid from the device 10 into the inner volume 237 and can define a top port 244 configured to be placed in fluid communication with the device 10 (e.g., a lid or other suitable portion of the device 10) to transfer an outlet flow of fluid from within the inner volume 237 of the second food compartment 235 to the device 10.

While the second food compartment 235 is described above as including and/or defining the ports 244, in other embodiments, a second food compartment need not define and/or include ports. In such embodiments, an inner volume of the second food compartment can be fluidically isolated from a volume outside of the second food compartment (e.g., as described above with reference to the first food compartment 230). In this manner, sidewalls of such a food compartment (second food compartment) can be configured to transfer thermal energy to the food items contained therein. For example, the second food compartment can be disposed in a portion of a device containing a volume of heated fluid such that thermal energy is transferred from the heated fluid to the food items contained in the second food compartment. In other embodiments, thermal energy associated with a volume of fluid flowing within a fluidically isolated portion of the device can be transferred to the portion of the device in which the second food compartment is disposed (e.g., transferred from the first portion 13 of the thermal container 11 to the second portion 14 of the thermal container 11 via the divider 12) and, in turn, transferred to the food items contained in the second food compartment.

The openings 241 of the divider 240 can be any suitable shape, size, and/or configuration. In some embodiments, the configuration and/or arrangement of the openings 241 defined by the divider 240 can be based at least in part on a desired amount of fluid flow therethrough. For example, in some embodiments, a first divider can include a number of openings each of which has a first size and a second divider can include the same number of openings each of which has a second size greater than the first size. In this manner, the second divider can be configured to allow a larger fluid flow rate therethrough the first divider. In other embodiments, a divider having a fewer number of openings can have a lower fluid flow rate therethrough than a divider having a greater number of openings. Thus, a fluid flow rate between the first portion 238 of the inner volume 237 and the second portion 239 of the inner volume 237 can be controlled by varying the size and/or number of openings defined by the divider 240. In some embodiments, the fluid flow rate through the divider 240 can be based at least in part on the one or more food items contained in the first portion 238 of the inner volume 237 and/or the one or more food items contained in the second portion 239 of the inner volume 237.

While the divider 240 is shown and described above as defining one or more openings 241 with a substantially circular shape, in other embodiments, a divider can define one or more openings arranged as, for example, slits, slots, channels, mesh, and/or the like. In other embodiments, a divider need not define one or more openings. In such embodiments, for example, the second food compartment 235 can define one or more fluid flow paths that can establish fluid communication between the device 10 and the first portion 238 and/or the second portion 239 of the inner volume 237. In some such embodiments, a second food compartment can define a fluid flow path (e.g., via a tube, conduit, or the like) between a port or the like and a second portion of an inner volume that is fluidically isolated from the first portion of the inner volume. That is to say, in some embodiments, the second portion 239 of the inner volume 237 can be placed in fluid communication with the device 10 while the first portion 238 of the inner volume 237 is fluidically isolated from the device 10 (or vice versa).

In some embodiments, a food compartment (e.g., the second food compartment 235) can include one or more valves or the like that can selectively control a flow of fluid therethrough. In such embodiments, the food compartment can be in a first configuration, in which the one or more valves establish fluid communication between a first portion of an inner volume and a device in which the food compartment is disposed while a second portion of the inner volume is fluidically isolated from the device. In some instances, the food compartment can be configured to transition from the first configuration to a second configuration (e.g., after a given time or the like), in which the one or more valves establish fluid communication between both the first portion and the second portion of the inner volume and the device or in which the second portion of the inner volume is in fluid communication with the device while the first portion of the inner volume is fluidically isolated from the device.

As described above, the cartridge 200 can be used in any suitable fluid immersion storage and/or cooking device such as, for example, the device 10 illustrated in FIG. 2. For example, in some instances, a user (e.g., a consumer) can position the cartridge 200 in the device 10, which can store the cartridge 200 and the food items contained therein at a suitable storage temperature (e.g., a refrigeration temperature), as described in detail in the '627 application. In this example, the first food compartment 230 can contain a meat and/or other protein while the second food compartment 235 can contain a starch disposed in the first portion 238 of the inner volume 237 and a vegetable disposed in the second portion 239 of the inner volume 237. Moreover, the cartridge 200 is inserted into the thermal container 11 in the predetermined orientation (described above) such that the first food compartment 230 is disposed in the first portion 13 of the thermal container 11 and the second food compartment 235 is disposed in the second portion 14 of the thermal container 11.

With the device 10 in the storage configuration, a fluid circulating through at least the first portion 13 of the thermal container 11 can remove thermal energy from the food item (e.g., the meat or other protein) contained in the first food compartment 230 and can then be cooled via the heat transfer system 16. In some instances, the fluid circulating through the first portion 13 of the thermal container 11 can also remove thermal energy from, for example, the divider 12, which in turn, removes thermal energy from the second portion 14 of the thermal container 11. Thus, the circulating fluid can also cool the second portion 14 of the thermal container 11 and/or at least the food items (e.g., the starch and vegetable) contained in the second food compartment 235. That is to say, the device 10 can store the food items contained in the second food compartment 235 at a desired storage temperature without circulating a fluid through the second portion 14 of the thermal container 11. In other embodiments, the device 10 can be configured to circulate a fluid through the second portion 14 of the thermal container 11.

In some instances, the device 10 can be transitioned from the storage configuration to the cooking configuration to cook the food items contained in the cartridge 200. For example, in some instances, the device 10 can activate one or more heating elements and can define a fluid flow path through the circulation system 15 that places the one or more heating elements in thermal and/or fluid communication with the circulating fluid. Thus, thermal energy is transferred to the fluid flowing through the circulation system 15, as described in detail in the '627 application. The heated fluid (e.g., at a sub-boiling temperature—less than 212° Fahrenheit (F)) can flow through and/or can be contained in the first portion 13 of the thermal container 11 such that the first food compartment 230 disposed therein is at least partially submerged. As described above, in some embodiments, the first food compartment 230 can be at least partially vacuum-sealed and the sidewalls 231 configured to transfer thermal energy therethrough. In this manner, the heated fluid within the first portion 13 of the thermal container 11 transfers at least a portion of its thermal energy to the food item (e.g., the meat or other protein) contained in the first food compartment 230. In other words, the food item contained in the first food compartment 230 is cooked via fluid immersion or sous-vide. Moreover, the device 10 can be configured to control the temperature of the circulating fluid accurately and precisely and thus, can be configured to cook the food item to a desired temperature.

In addition, while in the cooking configuration, the device 10 can cook the food items contained in the second food compartment 235 (e.g., the starch in the first portion 238 of the inner volume 237 and the vegetable in the second portion 239 of the inner volume 237). More specifically, in some embodiments, the arrangement of the second food compartment 235 is such that when the cartridge 200 is positioned in the thermal container 11, the ports 244 included in and/or defined by the sidewalls 236 establish fluid communication between the device 10 and the inner volume 237 of the second food compartment 235. For example, in some embodiments, each port 244 can be an opening that is covered and/or otherwise obstructed by a cover, lid, cap, seal, frangible sheet, etc. that can be removed by a user prior to disposing the cartridge 200 in the thermal container 11 and/or otherwise transitioned to an open configuration once disposed therein. In such embodiments, inserting the cartridge 200 into the thermal container 11 can be such that a conduit or the like is at least partially inserted through the ports 244. In other embodiments, the ports 244 (e.g., openings) can be substantially aligned with associated ports (openings) of the device 10. In some embodiments, the device 10 and/or the second food compartment 235 can include a seal or the like that is configured to form a substantially fluid-tight seal around an interface between the second food compartment 235 and the device 10. While the ports 244 are described above as being openings temporarily obstructed by a removable cover, cap, or seal, in other embodiments, each port 244 can be septum, a frangible seal, a membrane, a valve, and/or the like that can be engaged by a portion of the device 10 to transition from a closed configuration to an open configuration. For example, in some embodiments, each port 244 can be a septum that is pierced or punctured by a puncture member of the device 10 when the cartridge 200 is placed in the thermal container 11.

While the interface establishing fluid communication between the device 10 (e.g., at least a portion of the circulation system 15) and the inner volume 237 of the second food compartment 235 has been specifically described above, in other embodiments, a device and cartridge can form any suitable interface operable to establish fluid communication between the device and an inner volume of the cartridge. In some embodiments, such an interface can form, for example, a substantially fluid-tight seal that fluidically isolates a fluid flow path defined between, for example, the inner volume 237 of the second food compartment 235 and, for example, the second portion 14 of the thermal container 11. That is to say, the arrangement substantially prevents fluid from flowing into a volume defined between the second portion 14 of the thermal container 11 and an outer surface of the second food compartment 235.

With fluid communication established between the inner volume 237 of the second food compartment 235 and a portion of the circulation system 15, the device 10 can provide a heated fluid that flows from an outlet of the circulation system 15, through the inner volume 237 of the second food compartment 235, and into an inlet of the circulation system 15 (e.g., via the ports 244). Moreover, by disposing the food items in a fluid permeable bag, pouch, container, etc., the interface formed between the second food compartment 235 and the device 10 can be substantially free of obstructions that might otherwise result from loose food particles being inside the interface. As described above, in some instances, the heated fluid can be, for example, sub-boiling or less than about 212° F., while nonetheless, having a sufficient amount of thermal energy to cook the starch contained in the first portion 238 of the inner volume 237 and the vegetable contained in the second portion 239 of the inner volume 237. Thus, as the heated fluid flows through the first portion 238 and the second portion 239 of the inner volume 237, thermal energy is transferred to the respective food items contained therein. In other words, the food items contained in the second food compartment 235 are cooked to a desired temperature.

While the device 10 is described above as cooking the food items contained in the second food compartment 235 via a fluid having a sub-boiling temperature, in some embodiments, the device 10 can pump the heated fluid into the inner volume 237 of the second food compartment 235 with flow characteristic(s) otherwise associated with and/or similar to boiling fluid (e.g., water). For example, in some embodiments, the heated fluid can flow through the inner volume 237 of the second food compartment 235 with a sufficient amount of turbulence to move the food items contained in the first portion 238 and/or the second portion 239 of the inner volume 237. The turbulent flow of the heated fluid can be similar to a turbulence otherwise produced by boiling. As such, the movement of the food items can limit and/or substantially prevent the food items from sticking together and/or to a portion of the second food compartment 235. For example, in some instances, the first portion 238 of the inner volume 237 can contain rice and the turbulent flow can move the individual grains of rice to limit and/or substantially prevent the grains of rice from sticking together.

In other embodiments, the cartridge 200 can be used in a device configured to cook at least some of the food items contained in the second food compartment 235 via a fluid having a temperature above boiling (e.g., above 212° F.). In still other embodiments, the cartridge 200 can be used in a device configured to cook at least some of the food items contained in the second food compartment 235 via steam. In such embodiments, the device can be configured to heat a volume of fluid to generate steam (e.g., at or above the boiling point of the fluid for a given pressure), which in turn, flows through the second food compartment 235. In some embodiments, the heated fluid can be at least a portion of a volume of fluid circulating through the device (as described above with reference to the circulation system 15 of the device 10). In other embodiments, the steam can be produced, generated, and/or released from a steam generator or the like configured to receive a flow of the circulating fluid or a separate flow of fluid (e.g., from an exterior or separate fluid source). As such, in embodiments in which steam is generated, the steam can flow within a flow path through the second food compartment 235 to cook the food items contained therein.

As described above, the divider 240 disposed in the inner volume 237 separates the first portion 238 of the inner volume 237 from the second portion 239 of the inner volume 237. As described above, the openings 241 of the divider 240 (FIG. 9) can be any suitable size and/or arrangement. In some embodiments, the size and/or number of openings 241 defined by the divider 240 can control a rate of fluid flow between the first portion 238 of the inner volume 237 and the second portion 239 of the inner volume 237. For example, a divider defining larger holes or a greater number of holes can allow a greater bulk fluid flow therethrough than a divider defining smaller holes or a fewer number of holes. In some instances, controlling the rate of fluid flow through the divider 240 similarly controls the rate of thermal energy transferred to the food item (e.g., vegetable) contained in the second portion 239 of the inner volume. Thus, controlling the configuration and/or arrangement of the holes 241 defined by the divider 240 can allow for the parallel cooking of the food items contained in the first portion 238 and the second portion 239 of the inner volume 237 despite a difference in an amount of thermal energy sufficient to cook the food items a desired amount. For example, by controlling the configuration and/or arrangement of the openings 241 defined by the divider 240 can be such that a starch contained in the first portion 238 of the inner volume 237 can be cooked in parallel with a vegetable contained in the second portion 239 of the inner volume 237 despite a difference in an amount of thermal energy sufficient to cook the food.

Once the food items in the cartridge 200 are cooked, a user can remove the cartridge 200 from the device 10. In other embodiments, the device 10 can be configured to maintain the food at a warm storage temperature until the user removes the cartridge 200. With the cartridge 200 removed from the device, the user can open the first food compartment 230 and/or the second food compartment 235 by removing, for example, the removable seal or the like (described above). For example, in some embodiment, the removable seal can be a peel-away seal or a tear-away seal that can be removed from the first food compartment 230 and/or the second food compartment 235 in response to a force exerted by the user. With the first food compartment 230 and/or the second food compartment 235 opened, the user can remove the food items and place the food items on a plate. In some embodiments, the cartridge 200 can then be discarded (e.g., thrown away in the garbage).

Although not shown and/or described herein, in some embodiments, the first food compartment 230 and/or the second food compartment 235 can include any suitable packet, pouch, film, absorbent member, and/or the like that can contain and selectively release a sauce and/or seasoning. For example, in some embodiments, the first food compartment 230 can include an absorbent member containing an emulsified sauce or the like that is reconstituted by fluid released from the meat and/or other protein during cooking. In other embodiments, such absorbent members can absorb the fluid released from the meat and/or other protein during cooking without making a sauce or the like. In some embodiments, the first food compartment 230 and/or the second food compartment 235 can contain a dissolvable pouch or the like containing seasoning (e.g., salt and pepper, etc.). In such embodiments, the dissolvable pouch can be dissolved after exposure to a fluid (e.g., the fluid released by the meat or other protein in first food compartment 230 and/or the heated fluid flowing through the inner volume 237 of the second food compartment 235) for a predetermined time or the like.

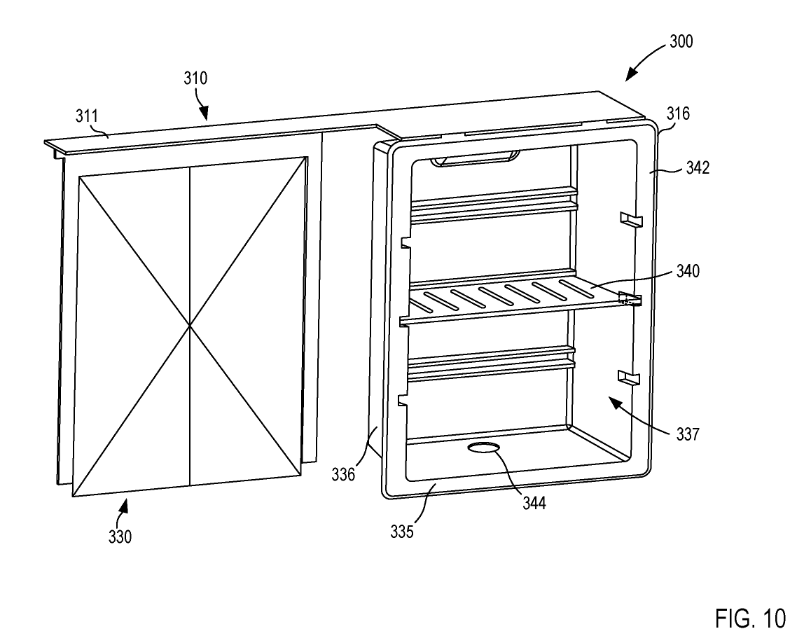

While the cartridge 200 is particularly shown and described above with reference to FIGS. 3-9, in other embodiments, a storage and/or cooking device (e.g., the device 10) can be used with any suitable cartridge. For example, FIG. 10 is a perspective view of a modular food cartridge 300 according to an embodiment. The modular food cartridge 300 (also referred to herein as “cartridge”) is configured to contain one or more pre-packaged food items and further configured to be inserted into a storage and/or cooking device such as the device 10 shown in FIG. 2. Thus, when the cartridge 300 is inserted into the device 10, the one or more food items contained in cartridge 300 can be stored in a suitable environment (e.g., at a suitable storage temperature) and in response to a change in an operating condition of the device 10 can be cooked at and/or to a desired temperature (e.g., at a suitable cooking temperature).

The cartridge 300 includes a frame 310, a first food compartment 330, and a second food compartment 335, as shown in FIG. 10. In this embodiment, the frame 310 includes a first member 311 and a second member 316. The first member 311 and the second member 316 can be formed of similar or dissimilar materials. As shown in FIG. 10, the first food compartment 330 is coupled to and/or otherwise suspended from the first member 311 and the second food compartment 335 is coupled to the second member 316. As described above with reference to the frame 210 of the cartridge 200, the frame 310 of the cartridge 300 can have any suitable shape, size, and/or configuration. For example, in some embodiments, the frame 310 (e.g., the first member 311 and/or the second member 316) can have a size and/or shape that corresponds to and/or is associated with a size and/or shape of a thermal container of a storage and/or cooking device (e.g., the thermal container 11 of the device 10). In some embodiments, the arrangement is such that the cartridge 300 can be inserted and/or disposed within a thermal container (e.g., the thermal container 11) in a predetermined and/or desired position, orientation, etc. Therefore, as described above, food contained in the first food compartment 330 and/or the second food compartment 335 can be cooked in a desired and/or predetermined portion of the thermal container (e.g., the thermal container 11).

Although not shown in FIG. 10, in some embodiments, the frame 310 can include any suitable identification tag, code, and/or device that is associated with data relating to the one or more food items contained in the cartridge 300. For example, in some embodiments, the frame 310 can include a barcode, a quick response (QR) code, a near field communication (NFC) device or radio, a radio frequency identification (RFID) device or radio, and/or the like. In some embodiments, such a tag, code, and/or device can be, for example, embedded in the frame 310, printed on the frame 310, and/or otherwise coupled to the frame 310. In such embodiments, the device 10 can include a corresponding scanner, reader, and/or transceiver configured to scan the code on the frame 310 (e.g., bar or QR code) and/or otherwise receive a signal from an electronic identification device or radio (e.g., NFC or RFID device or radio). Thus, based on the scan and/or signal, the device 10 can determine and/or reference data associated with the cartridge 300 (e.g., data associated with the food contained in the cartridge 300, storing and/or cooking instructions, times, temperatures, expiration dates, and/or any other suitable information). In some embodiments, the frame 310 can include multiple RFID devices and/or components. For example, in some embodiments, a frame (e.g., the frame 300) can include a first RFID device and/or component aligned and/or otherwise associated with a first food compartment (e.g., the first food compartment 330) and a second RFID device and/or component aligned and/or otherwise associated with a second food compartment (e.g., the second food compartment 335).

In the embodiment shown in FIG. 10, the first food compartment 330 is configured to contain, for example, a protein or the like (as described above with reference to the first food compartment 230). The first food compartment 330 can be a flexible pouch, bag, package, and/or the like. The flexible pouch or the like can have an amorphous shape (e.g., having a shape based on, for example, its contents, rather than a predetermined shape). In some embodiments, one or more food items can be disposed in the inner volume of the first food compartment 330 during a processing or packaging process and once the food item(s) are disposed therein, the first food compartment 330 can be at least partially vacuum-sealed.

The first food compartment 330 is formed of a material that is fluid impermeable and thermally conductive. For example, with the cartridge 300 configured for use in the device 10 or other suitable fluid immersion storage and/or cooking device, forming the first food compartment 330 from a fluid impermeable material is such that the one or more food items disposed in the inner volume of the first food compartment 330 are fluidically isolated from the fluid flowing through the device 10. Conversely, by forming the first food compartment 330 of a thermally conductive material, the one or more food items disposed in the inner volume of the first food compartment 330 are placed in thermal communication with the fluid flowing through the device 10, thereby allowing heat transfer between the one or more food items and the fluid. In addition, in the embodiment shown in FIG. 10, the first food compartment 330 is coupled and/or attached to the first member 311 of the frame 310. In some embodiments, the first food compartment 330 can be coupled to the first member 311 of the frame 310 via an adhesive, an ultrasonic weld, a thermal weld, one or more mechanical clips or fasteners, and/or the like.

Although not shown in FIG. 10, the first food compartment 330 can be similar to and/or can include any suitable feature and/or component of the first food compartment 230. For example, the first food compartment 330 can include and/or can be formed of a thermally conductive material and/or a ferromagnetic element or the like that can be energized via induction to transfer thermal energy to one or more food items contained therein, as described above with reference to the first food compartment 230. In some embodiments, the first food compartment 330 can include and/or can be at least partially formed of an absorbent material or the like that can absorb fluid released from the food contained therein during cooking, as described above with reference to the first food compartment 230. In addition, in some embodiments, the absorbent material can be impregnated with a seasoning, condensed sauce or fluid, paste, marinade, etc., as described above with reference to the first food compartment 230.

The second food compartment 335 of the cartridge 300 includes a set of sidewalls 336, a divider 340, and a flange 342. The sidewalls 336 collectively define an inner volume 337. The inner volume 337 is configured to contain one or more food items. For example, in some embodiments, the inner volume 337 can include one or more food items of a first type such as, for example, a starch or the like, and one or more food items of a second type such as, for example, a vegetable. In other embodiments, the inner volume 337 can be configured to contain food items of a similar type. In some embodiments, the divider 340 can be configured to partially and/or completely divide and/or separate the inner volume 337 into a first portion and a second portion, as described above with reference to the second food compartment 235. Although not shown in FIG. 10, in some embodiments, the one or more food items contained in the inner volume 337 can be disposed in fluid permeable bag, pouch, container, etc. For example, in some embodiments, the inner volume 337 can contain a starch such as rice that is contained in a fluid permeable bag configured to allow the rice to be handled as a single bulk item while still placing the rice in fluid communication with a fluid operable to cook the rice. In some embodiments, such an arrangement can, for example, simplify one or more packaging processes, handling process, and/or the like.

The sidewalls 336 define and/or include at least one port 344 configured to establish selective fluid communication between a portion of a storage and/or cooking device (e.g., the device 10) and the inner volume 337 of the second food compartment 335. Although not shown in FIG. 10, in some embodiments, the divider 340 can include and/or can define one or more openings each of which is configured to establish selective fluid communication between, for example, a first portion of the inner volume 337 and a second portion of the inner volume 337, as described above with reference to the second food compartment 235. The one or more ports 344 can be any suitable configuration and disposed in any suitable arrangement, as described above with reference to the second food compartment 235. In some embodiments, for example, the port 344 can be and/or the sidewalls 336 can otherwise include a steam vent or valve configured to allow a flow of steam, gas, vapor, and/or fluid therethrough.

The second food compartment 335 can be formed of any suitable material and/or in any suitable manner. For example, in some embodiments, the second food compartment 335 is thermoformed or the like. As shown in FIG. 10, the second food compartment 335 is disposed within, for example, the second member 316 of the frame 310. For example, in some embodiments, the second member 316 of the frame 310 is a ring or the like within which the second food compartment 335 is disposed. Although not shown, the second food compartment 335 includes and/or is at least temporarily coupled to a removable seal or cover configured to provide access to the inner volume 337 of the second food compartment 335. In addition, the removably seal can be configured to at least temporarily couple the second food compartment 335 to the second member 316 of the frame 310. For example, in some embodiments, the removable seal can be a film or the like configured to wrap around and/or otherwise attach to at least a portion of the second member 316 of the frame 310 and at least a portion of the flange 342 of the second food compartment 335. In this manner, the removable seal can be configured to maintain the second food compartment 335 in a fixed position relative to the frame 310 when the removable seal is coupled about the second member 316 of the frame 310 and the second food compartment 335. In some embodiments, the removable seal can be pealed and/or otherwise removed from the second member 316 of the frame 310 and/or the second food compartment 335 to allow access to the inner volume 337 of the second food compartment 335. In this manner, the second food compartment 335 can function in a substantially similar manner to the second food compartment 235 described above with reference to FIGS. 7 and 9.

In some instances, the use of the removable seal (e.g., the film or the like) can allow food items to be disposed and/or packaged within the first food compartment 330 independent of food items disposed and/or packaged within the second food compartment 335. For example, the food items (e.g., protein or the like) can be disposed and/or packaged within the first food compartment 330 at a first food provider, packager, manufacturer, etc. while the food items (e.g., starch, vegetables, etc.) can be disposed and/or packaged within the second food compartment 335 at a second food provider, packager, manufacturer, etc. different from the first food provider, etc. Moreover, the first food compartment 330 and the second food compartment 335 can later be assembled and/or coupled to the frame 310 after the food items are disposed in their respective food compartments. In this manner, the removable seal can allow the second food compartment 335 to be coupled to the frame 310 independent of and/or after the food items are disposed in the first food compartment 330 and/or the second food compartment 335.

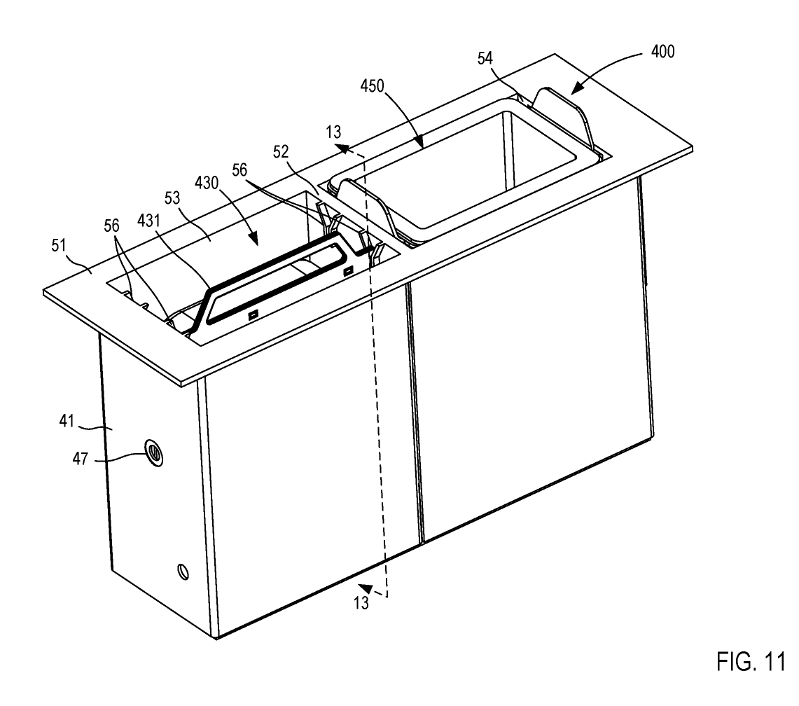

While the cartridges 200 and 300 are described above as including a frame that is coupled to a first food compartment and a second food compartment, in other embodiments, a modular food cartridge and/or food cartridge assembly can have any suitable configuration. FIGS. 11-13 illustrate a modular food cartridge assembly 400 according to an embodiment. The modular food cartridge assembly 400 (also referred to herein as “cartridge assembly”) is configured to contain one or more pre-packaged food items and further configured to be inserted into a storage and/or cooking device such as the device 10 shown in FIG. 2. When the cartridge assembly 400 is inserted into the device 10, the one or more food items contained in cartridge assembly 400 can be stored in a suitable environment (e.g., at a suitable storage temperature) and in response to a change in an operating condition of the device 10 can be cooked at and/or to a desired temperature (e.g., at a suitable cooking temperature).

As shown in FIGS. 11-13, in some embodiments, a fluid immersion cooking device (e.g., the device 10 shown in FIG. 2) can include a thermal container 41 having a first portion 43 (or volume) and a second portion 44 (or volume), which are separated by a divider 42. The first portion 43 of the thermal container 41 defines one or more openings 47 configured to selectively place the first portion 43 (or volume) in fluid communication with a portion of the fluid immersion cooking device (not shown). Similarly, the second portion 44 of the thermal container 41 includes and/or is coupled to a port 49 configured to selectively place the second portion 44 of the thermal container 41 in fluid communication with a portion of the fluid immersion cooking device. In some embodiments, the thermal container 41 can be substantially similar in form and/or function to the thermal container 11 described above with reference to FIG. 2. As such, the first portion 43 can be configured to receive a first portion of a modular food cartridge (or cartridge assembly) that contains, for example, a first kind of food (e.g., meats and/or other proteins) and the second portion 44 can be configured to receive a second portion of the modular food cartridge (or cartridge assembly) that contains, for example, a second kind of food (e.g., vegetables, starches, carbohydrates, and/or the like). Thus, each of the first portion 43 and the second portion 44 can receive (e.g., via the opening(s) 47 and the port 49, respectively) a flow of fluid that is operable in (1) storing the food contained therein at a desired storage temperature and/or (2) cooking the food contained therein at or to a desired cooking temperature. Moreover, as described above, the first portion 43 can have a size and/or shape that is different from a size and/or shape of the second portion 44. Thus, the first portion and the second portion of the modular food cartridge or cartridge assembly (e.g., the cartridge assembly 400) can have size and/or shape that corresponds with and/or is based on the size and/or shape of the first portion 43 and the second portion 44, respectively, of the thermal container 41. As described above, this arrangement can ensure, for example, that the modular food cartridge (or cartridge assembly) is inserted into the thermal container 41 in a single, predetermined orientation.

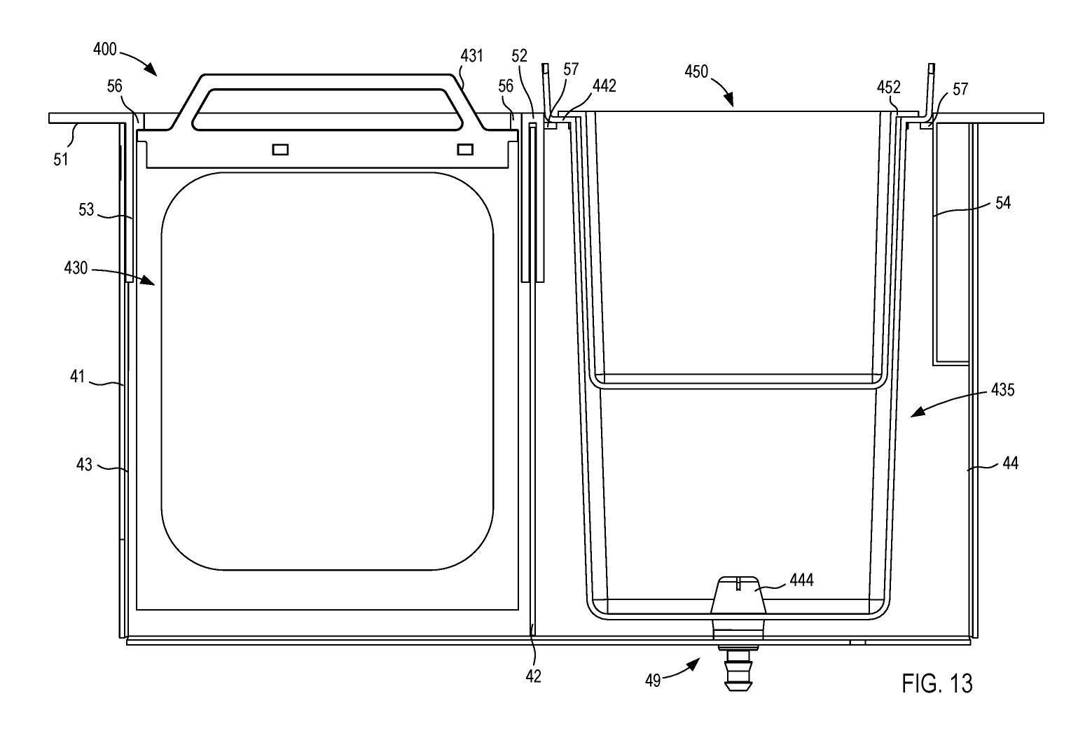

In the embodiment shown in FIGS. 11-13, the thermal container 41 includes and/or is coupled to a cover 51. The cover 51 includes a first portion 53 and a second portion 54, which are separated by a divider 52. The cover 51 is configured to couple to and/or otherwise engage the thermal container 41 such that the first portion 53 of the cover 51 is at least partially disposed within the first portion 43 of the thermal container 41 and the second portion 54 of the cover 51 is at least partially disposed within the second portion 44 of the thermal container 41 (see e.g., FIG. 13). As shown, the first portion 53 of the cover 51 includes a set of mounting protrusions 56 configured to selectively engage a portion of a food cartridge (e.g., a first portion of the cartridge assembly 400) to at least temporarily maintain the portion of the food cartridge in a desired and/or fixed position therein. Likewise, the second portion 54 of the cover 51 includes a set of rails 57 (or mounting protrusions) configured to selectively engage a portion of the food cartridge (e.g., a second portion of the cartridge assembly 400) to at least temporarily maintain the portion of the food cartridge in a desired and/or fixed position therein.

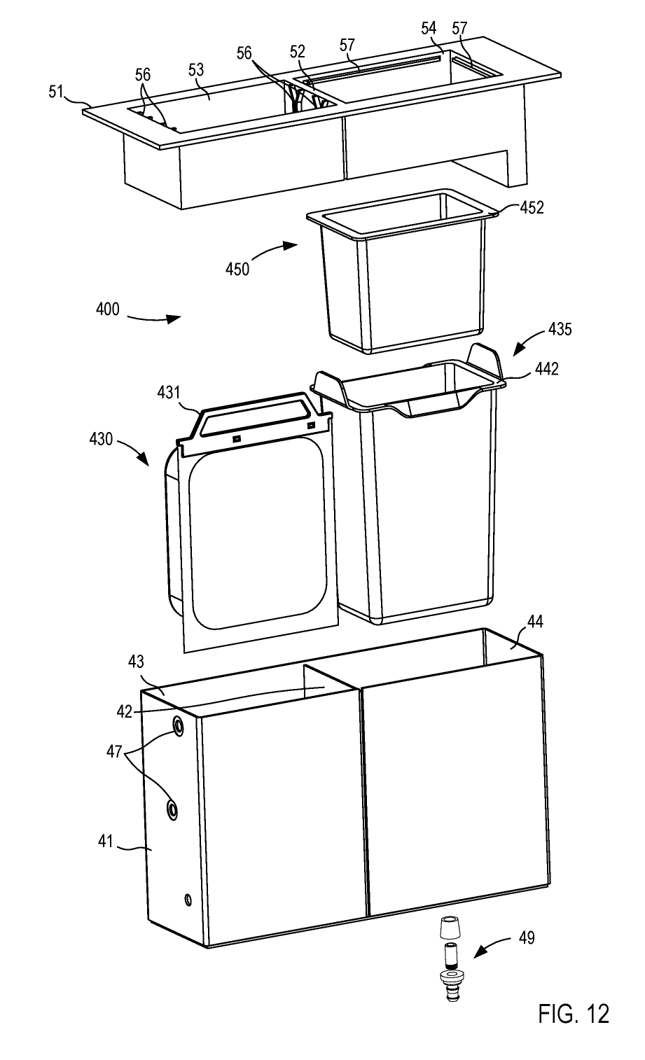

As shown in FIGS. 12 and 13, the cartridge assembly 400 includes a first food compartment 430, a second food compartment 435, and a third food compartment 450. The first food compartment 430 is configured to contain, for example, a protein or the like (as described above with reference to the first food compartment 230). The first food compartment 430 can be a flexible pouch, bag, package, and/or the like. The flexible pouch or the like can have an amorphous shape (e.g., having a shape based on, for example, its contents, rather than a predetermined shape). In some embodiments, one or more food items can be disposed in the inner volume of the first food compartment 430 during a processing or packaging process and once the food item(s) are disposed therein, the first food compartment 430 can be at least partially vacuum-sealed. In this manner, the first food compartment 430 can be substantially similar in form and/or function to the first food compartments 230 and/or 330 and thus, some aspects of the first food compartment 430 are not described in further detail herein.

The first food compartment 430 includes a handle 431 configured to be coupled to a portion of the first food compartment 430 (e.g., a flanged portion or the like). As shown, for example, in FIGS. 11 and 13, the arrangement of the handle 431 can be configured to selectively engage a portion of the mounting protrusions 56 of the first portion 53 of the cover 51. For example, in some embodiments, the mounting protrusions 56 can define a slot or channel configured to receive a portion of the first food compartment 430, which can be advanced therethrough to place a portion of the handle 431 in contact with one or more surfaces of the mounting protrusions 56. Accordingly, the arrangement of the handle 431 and the mounting protrusions 56 can be operable in at least temporarily maintaining the first food compartment 430 in a desired and/or fixed position within the first portion 43 of the thermal container 41. Moreover, the handle 431 can provide a means and/or can otherwise facilitate a user inserting or removing the first food compartment 430 into or from the first portion 43 of the thermal container 431. While the handle 431 is described above as being used to temporarily maintain the first food compartment 430 in a desired or fixed position within the first portion 43 of the thermal container 41, in other embodiments, a food compartment need not include a handle. For example, in some embodiments, a first food compartment can be a pouch, bag, package, etc. that defines at least one hole or opening that can be positioned about a hanger or protrusion of first portion 43 to suspend, hang, and/or hold the first food compartment 430 in a desired position relative to the second portion 43.

The second food compartment 435 of the cartridge assembly 400 can be any suitable shape, size, and/or configuration. As described above with reference to the second food compartments 235 and 335, the second food compartment 435 is configured to contain one or more food items. For example, in some embodiments, the second food compartment 435 can include one food item such as, for example, a starch or the like. In other embodiments, the second food compartment 435 can include more than one food item such as, for example, a starch and a vegetable (or any other suitable food item or combination thereof). Although not shown in FIGS. 11-13, in some embodiments, the one or more food items contained in the second food compartment 435 can be disposed in fluid permeable bag, pouch, container, etc. For example, in some embodiments, the second food compartment 435 can contain a starch such as rice that is contained in a fluid permeable bag configured to allow the rice to be handled as a single bulk item while still placing the rice in fluid communication with a fluid operable to cook the rice. In some embodiments, such an arrangement can, for example, simplify one or more packaging processes, handling process, and/or the like.

As shown in FIGS. 12 and 13, the second food compartment 435 includes and/or forms a flange 442 and a port 444. The flange 442 of the second food compartment 435 is configured to be placed in contact with, for example, the rails 57 of the second portion 54 of the cover 51 when the second food compartment 435 is inserted into the second portion 44 of the thermal container 41. Thus, the second food compartment 435 can be at least temporarily maintained in a desired and/or fixed position within the second portion 44 of the thermal container 41. Moreover, as shown in FIG. 13, the second food compartment 435 can be disposed within the second portion 44 of the thermal container 41 such that the port 444 engages and/or is otherwise aligned with the port 49 of the thermal container 41, thereby placing an inner volume of the second food compartment 435 in fluid communication with a portion of the fluid immersion cooking device. Thus, a fluid can be transferred into or through the second food compartment 435 to store and/or cook the one or more food items contained therein, as described above.

In the embodiment shown in FIGS. 11-13, the cartridge assembly 400 includes a third food compartment 450. The third food compartment 450 is configured to include and/or contain one or more food items. For example, in some embodiments, the third food compartment 450 can include one food item such as a vegetable. In other embodiments, the third food compartment 450 can include more than one food item such as, for example, a starch and a vegetable (or any other suitable food item of combination thereof). As described above with reference to the second food compartment 435, in some embodiments, the third food compartment 450 can be configured to receive a food item (e.g., vegetable) disposed in a fluid permeable bag, pouch, or the like. In other embodiments, the third food compartment 450 can include a bulk or loose food item. In still other embodiments, the third food compartment 450 can be a prepackaged container with a food item disposed therein (e.g., during a packaging process or the like). Although not shown in FIGS. 11-13, in some embodiments, the third food compartment 450 can include one or more openings and/or perforations configured to place an inner volume of the third food compartment 450 in fluid communication with a volume outside of the third food compartment 450. In some embodiments, the third food compartment 450 can be formed from a fluid permeable material or the like. In other embodiments, the third food compartment 450 can be formed of a material that is fluid impermeable but configured to transfer thermal energy to or from the inner volume thereof (e.g., from or to a fluid within the second portion 44 of the thermal container 41.

As shown in FIGS. 12 and 13, the third food compartment 450 is configured to be at least partially disposed within the second food compartment 435. More specifically, the third food compartment 450 includes and/or forms a flange 452 configured to be placed in contact with the flange 442 of the second food compartment 435. In this manner, the third food compartment 450 can be removably disposed within the second food compartment 435. Thus, when the second food compartment 435 is removably disposed in the second portion 44 of the thermal container 41 and the third food compartment 450 is removably disposed in the second food compartment 435, the third food compartment 450 is placed in thermal and/or fluid communication with the second portion 44 of the thermal container 41 (e.g., via the port 444). Thus, a fluid can be transferred into or through the second food compartment 435 to store and/or cook the one or more food items contained within the second food compartment 435 and one or more food items contained within the third food compartment 450.

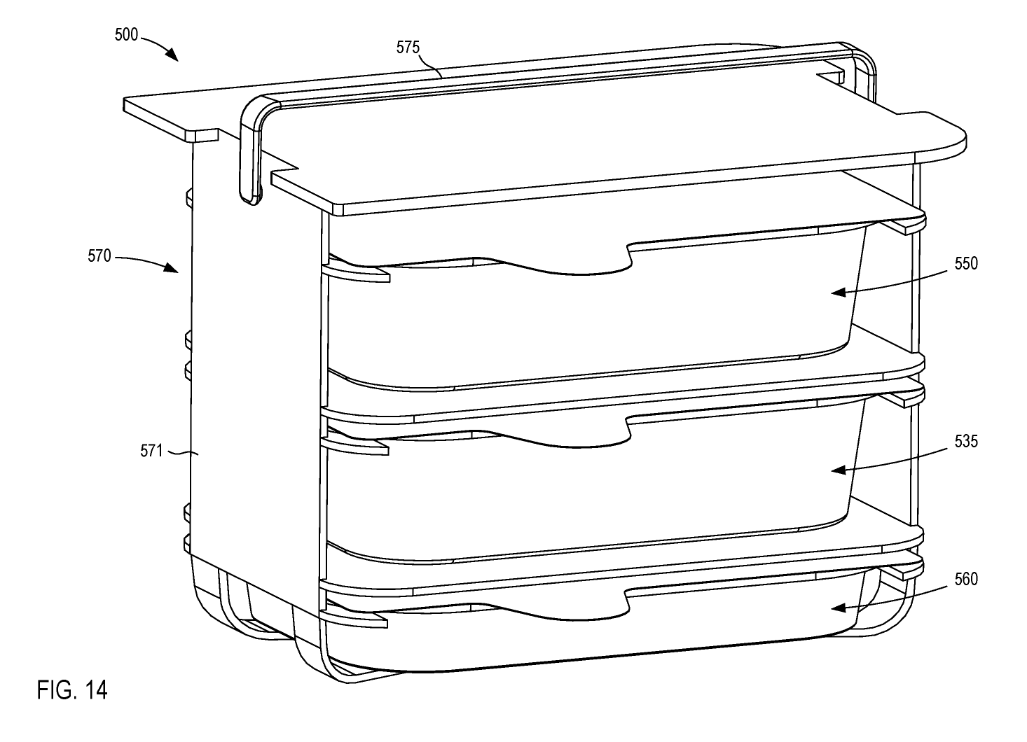

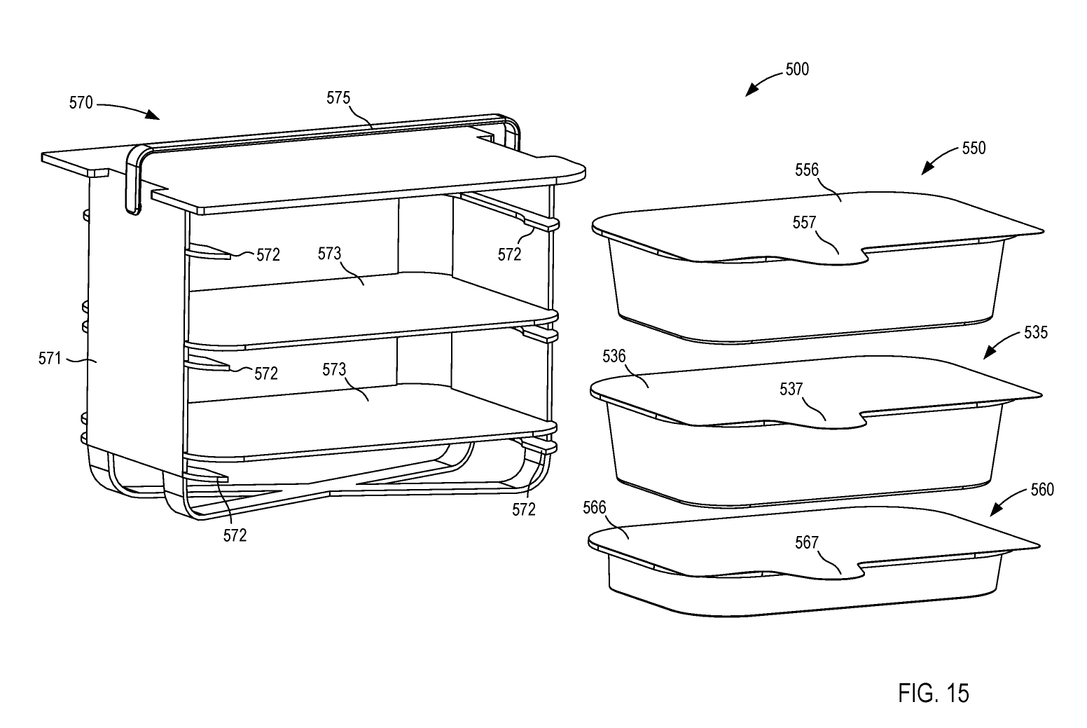

While the second food compartment 435 and the third food compartment 450 are particularly described above with reference to FIGS. 11-13, in other embodiments, a modular food cartridge assembly can include one or more food compartments having any suitable shape, size, and/or configuration. For example, FIGS. 14 and 15 illustrate a portion of a modular food cartridge assembly 500 according to another embodiment. The portion of the modular food cartridge assembly 500 (also referred to herein as “portion of the cartridge assembly” or, for simplicity, “cartridge assembly”) is configured to contain one or more pre-packaged food items and further configured to be inserted into a storage and/or cooking device such as the device 10 shown in FIG. 2. When the cartridge assembly 500 is inserted into such a device, the one or more food items contained in cartridge assembly 500 can be stored in a suitable environment (e.g., at a suitable storage temperature) and in response to a change in an operating condition of the device, can be cooked at and/or to a desired temperature (e.g., at a suitable cooking temperature).

As described in detail above, a fluid immersion cooking device (e.g., the device 10 shown in FIG. 2) can include a thermal container having a first portion (or volume) and a second portion (or volume), which are separated by a divider. In some embodiments, such a fluid immersion cooking device can be substantially similar to and/or the same as the fluid immersion cooking devices described in the '627 application incorporated by reference above. As such, the first portion can be configured to receive a first portion of a modular food cartridge (or cartridge assembly) that contains, for example, a first kind of food (e.g., meats and/or other proteins) and the second portion can be configured to receive a second portion of the modular food cartridge (or cartridge assembly) that contains, for example, at least a second kind of food (e.g., vegetables, starches, carbohydrates, and/or the like). Each of the first portion and the second portion can receive a flow of fluid that is operable in (1) storing the food contained therein at a desired storage temperature and/or (2) cooking the food contained therein at or to a desired cooking temperature. As described above, the first portion can have a size and/or shape that is different from a size and/or shape of the second portion, which in turn, can ensure the cartridge assembly being positioned in the fluid immersion device in a predetermined manner.

In the embodiment shown in FIGS. 14 and 15, the cartridge assembly 500 can include, for example, one, two, three, four, or more food compartments. For example, although not shown in FIGS. 14 and 15, the cartridge assembly 500 can include a first food compartment configured to contain, for example, a first food item such as a protein or the like. In some embodiments, the first food compartment can be substantially similar to the first food compartment 430 described above with reference to FIGS. 11-13. Accordingly, the first food compartment of the cartridge assembly 500 is not shown or described in further detail and should be considered as substantially similar to the first food compartment 430 unless the context clearly indicates otherwise.

The cartridge assembly 500 also includes a second food compartment 535, a third food compartment 550, a fourth food compartment 560, and a carrier 570, as shown in FIGS. 14 and 15. The second food compartment 535 is configured to contain a second food item such as, for example, a starch (as described above with reference to the second food compartments 135, 235, 335, and/or 445). The third food compartment 550 is configured to contain a third food item such as, for example, a vegetable (as described above with reference to the third food compartment 450). The fourth food compartment 560 is configured to container a fourth food item such as, for example, a sauce or the like.

The food compartments 535, 550, and 560 and the carrier 570 can be any suitable shape, size, and/or configuration. For example, as described above, the carrier 570 and the food compartments 535, 550, and 560 can have a size and/or shape that is at least partially based on a size and/or shape of the second portion of the fluid immersion device. Moreover, the size and/or shape of the carrier 570 and the food compartments 535, 550, and 560 can be such that the carrier 570 and the food compartments 535, 550, and 560 will not fit in the first portion of the fluid immersion device (e.g., a larger than the first portion of the fluid immersion device). In some instances, such an arrangement can ensure that the second food compartment 535, the third food compartment 550, and the fourth food compartment 560 (with or without the carrier) are positioned in the second portion of the fluid immersion device and not the first portion. For example, in some embodiments, a fluid immersion device can be configured to store and/or cook a food item (first type of food such as a protein) in the first portion thereof in a manner that may not be a recommended storage and/or cooking manner for a food item of a different type (e.g., a food type such as starch, vegetable, and/or the like). Thus, forming the food compartments 535, 550, and 560 with a predetermined size that is based on a size of the second portion of the fluid immersion device can ensure the food items contained in the food compartments are stored and/or cooked in a desired manner.

The carrier 570 can be formed of any suitable material such as one or more plastics, polymers, metals, metal alloys, etc. As described in further detail herein, the carrier 570 is configured to at least temporarily receive and/or couple to the food compartments 535, 550, and/or 560 to facilitate loading the food compartments 535, 550, and/or 560 into the second portion of the fluid immersion device or facilitate unloading the food compartments 535, 550, and/or 560 from the second portion of the fluid immersion device. In some embodiments, the carrier 570 can be configured for a single use and can be discarded with the food compartments once the food items are removed therefrom. In other embodiments, the carrier 570 can be reusable (e.g., can be used in multiple cycles of storing and/or cooking the food items contained in the food compartments. Although shown in FIGS. 14 and 15 as being independent of the fluid immersion device, in some embodiments, the carrier 570 can be operably or movably coupled to the second portion of the fluid immersion device. In such embodiments, the carrier 570 can move along a path or track and/or via one or more sliders, rollers, etc. between a first position in which the carrier 570 is disposed substantially outside of the second portion or second volume of the fluid immersion device, and a second position in which the carrier 570 is disposed inside the second portion or second volume of the fluid immersion device.

As shown in FIGS. 14 and 15, the carrier 570 of the cartridge assembly 500 includes a frame 571, a set of mounting rails 572, a set of dividers 573, and a handle 575. The frame 571 can be any suitable shape, size, and/or configuration. For example, in some embodiments, at least a portion of the frame 571 can be open to allow at least one of the second food compartment 535, the third food compartment 550, and/or the fourth food compartment 560 to be disposed therein. As described above, the frame 571 can have a size and/or shape that is associated with and/or at least partially based on a size and/or shape of the second portion of the fluid immersion device. Moreover, the handle 575 of the carrier 570 is coupled to the frame 571 and can facilitate the insertion and/or removal of the carrier 570 into the second portion of the fluid immersion device.

The mounting rails 572 of the carrier 570 extend from an inner surface of the frame 571 and are configured to receive, couple to, and/or otherwise support the food compartments 535, 550, and/or 560. In some embodiments, at least a portion of the mounting rails 572 can form a contour or the like that substantially corresponds to the food compartments 535, 550, and/or 560 (see e.g., FIG. 15). In this manner, when the food compartments 535, 550, and/or 560 are placed in a desired position on or along the mounting rails 572, a surface of the mounting rails 572 forming the contour can selectively engage and/or contact the food compartments 535, 550, and/or 560 to limit and/or substantially prevent the food compartments 535, 550, and/or 560 from sliding along the mounting rails 572 (e.g., sliding along and subsequently falling off the mounting rails 572. Moreover, as shown in FIG. 15, the dividers 573 of the carrier 570 can be disposed between the mounting rails 572 to divide and/or at least partially separate the carrier 570 into a set of sections (e.g., three sections in this embodiment), each of which receives one of the food compartments 535, 550, or 560. In some instances, the dividers 573 can be vertically spaced in such a manner that corresponds with a height of the food compartment 535, 550, and/or 560 contained therein. For example, in some embodiments, the dividers 573 can be evenly spaced. In other embodiments, such as the embodiment shown in FIGS. 14 and 15, the dividers 573 can be unevenly spaced based at least in part on a height of the food compartment configured to be disposed within that section of the carrier 570.

The food compartments 535, 550, and 560 can be any suitable shape, size, and/or configuration. For example, as shown in FIGS. 14 and 15, the food compartments 535, 550, and 560 can each be a tray, container, pouch, dish, bowl, and/or the like configured to receive a food item. Each of the food compartments 535, 550, and 560 is removably coupled to a cover 536, 556, and 566, respectively, and each of the covers 536, 556, and 566 includes and/or forms a tab 537, 557, and 567, respectively. In some embodiments, the covers 536, 556, and/or 566 can be, for example, a removable film or the like that this temporarily coupled to the food compartments 535, 550, and/or 560, respectively. In some embodiments, the covers 536, 556, and/or 566 and/or at least a portion thereof can be fluid permeable. In other embodiments, the covers 536, 556, and/or 566 can be fluid impermeable. In still other embodiments, a food compartment such as the food compartment 535, 550, and/or 560 does not include a cover.

The tabs 537, 557, and 567 can be manipulated by a user to remove the cover from the food compartment. Although not shown in FIGS. 14 and 15, in some embodiments, the tabs 537, 557, and 567 can each include a radio frequency identification (RFID) tag and/or any other suitable identification and/or communication device that is embedded into the corresponding tab 537, 557, and 567. Moreover, by positioning and/or embedding the RFID tag into the tabs 537, 557, and 567 of the covers 536, 556, and 567, respectively, the RFID tag can be spaced apart from a body portion of the food compartments 535, 550, and/or 560, respectively. In embodiments in which at least a portion of the food compartments 535, 550, and/or 560 are formed of a metal such as aluminum or the like, offsetting the RFID tags can reduce an interference which may otherwise result from the RFID tag being in contact with and/or within a close proximity to the metal material or the like.

As described above, in some embodiments, the size, shape, and/or configuration of the food compartments 535, 550, and/or 560 can be based at least in part on a type of food item that is contained therein. For example, in some embodiments, the second food compartment 535 can be configured to contain a starch or the like. In such embodiments, the second food compartment 535 can be at least semi-fluid permeable and/or can include a port or the like (as described above with reference to the second food compartment 435) configured to allow a flow of fluid into the second food compartment 535. In this manner, when the second food compartment 535 is disposed within the second portion of the fluid immersion device, a volume of fluid can flow into and/or through the second food compartment 535 to cook (e.g., boil, steam, heat, etc.) the food item (e.g., a starch such as rice) contained therein. The third food compartment 550 likewise can be at least semi-fluid permeable and/or can include a port or the like configured to allow a flow of fluid intro the third food compartment 550 to cook the food item (e.g., a vegetable or the like) contained therein. Conversely, in some embodiments, the fourth food compartment 560 can be fluid impermeable such that the fourth food item (e.g., a sauce) contained therein is fluidically isolated from a volume outside of the fourth food compartment 560. As described above with reference to the first food compartments 130, 230, 330, and/or 430, the fourth food compartment 560 can be configured to transmit thermal energy from a fluid within the second portion of the fluid immersion device, through one or more walls of the fourth food compartment 560, and to the fourth food item.

While the cartridges (cartridge assemblies) 200, 300, 400, and/or 500 are particularly shown and described above, it should be understood that various changes in form and/or function can be made. Moreover, it should be understood that any suitable feature and/or configuration of a cartridge according to a particular embodiment can be included and/or incorporated in any of the embodiments described herein. Thus, while the cartridges (cartridge assemblies) 200, 300, 400, and/or 500 are shown as having different configurations and/or arrangements, it should be understood that the cartridges (cartridge assemblies) 200, 300, 400 and/or 500 can function in a substantially similar manner when used in, for example, a fluid immersion cooking device and/or the like. By way of example, while the food compartments 535 and/or 550 are described above as including at least a portion that is fluid permeable, the food compartments 535 and/or 550 can include one or more ports, openings, piercable membranes, etc., as described above with reference to the food compartments 235, 335, and/or 435. Moreover, while the food cartridges 535, 550, and 560 are shown as being disposed in a particular arrangement or position within the carrier 570, in other embodiments, the food cartridges 535, 550, and 560 can be in any suitable arrangement and/or position within the carrier 570. For example, in some embodiments, the second food compartment 535 can be disposed above the third food compartment 550, which in turn, is disposed about the fourth food compartment 560. In other embodiments, however, the second food compartment 535 can be disposed between the third food compartment 550 and the fourth food compartment 560. In still other embodiments, the food compartments 535, 550, and/or 560 can be disposed in any suitable arrangement.

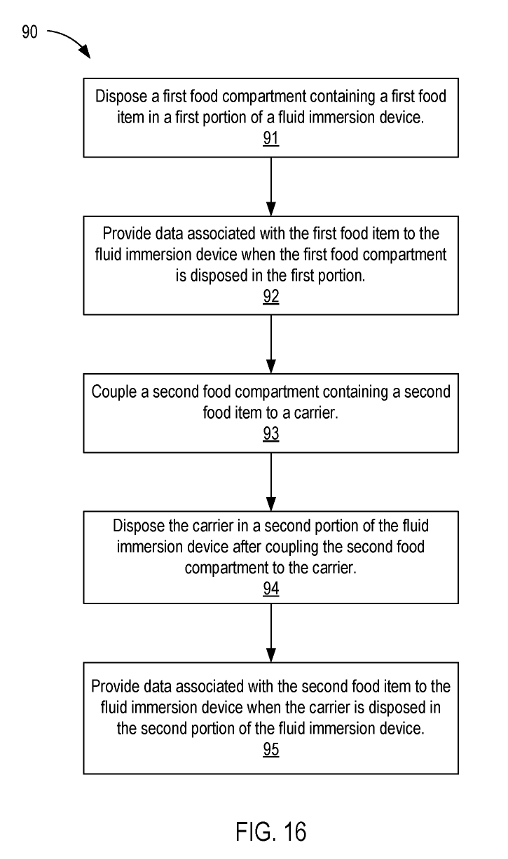

FIG. 16 is a flowchart illustrating a method 90 of providing food items for use in a fluid immersion device according to an embodiment. The fluid immersion device can be any suitable device such as those described in detail herein. In some embodiments, the fluid immersion device can be substantially similar to and/or the same as those described in the '627 application incorporated by reference above. In some embodiments, such a fluid immersion device can include, for example, a first portion configured to store and/or cook one or more food items and a second portion configured to store and/or cook one or more food items.

As described in detail above, the first portion of the fluid immersion device can be and/or can include a thermal container configured to receive and/or circulate a volume of fluid therethrough. In some embodiments, the fluid immersion device can be transitioned between a first configuration (e.g., a storage configuration) and a second configuration (e.g., a cooking configuration). For example, in some embodiments, a volume of fluid contained in and/or flowing through the first portion (or first thermal container) is cooled or chilled to a predetermined and/or desired storage temperature suitable for storing a food item when the fluid immersion device is in the first configuration. In some embodiments, the fluid immersion device can be transitioned to the second configuration in which the volume of fluid contained in and/or flowing through the first portion (or first thermal container) is heated to a predetermined and/or desired cooking temperature suitable for cooking the food item. In a similar manner, the second portion (or second thermal container) can be in a storage configuration in which thermal energy is transferred from the second portion to the first portion of the fluid immersion device (as described in detail in the '672 application). When the fluid immersion device is transitioned to the second configuration, at least a portion of the heated fluid can flow into the second portion (or second thermal container) to heat and/or cook one or more food items disposed therein.

The method 90 of providing food items for use in a fluid immersion device can be used to provide food items to the fluid immersion device described above. In some embodiments, for example, the method 90 includes disposing a first food compartment containing a first food item in the first portion of the fluid immersion device, at 91. The first food compartment can be any suitable shape, size, and/or configuration. For example, in some embodiments, the first food compartment can be substantially similar to the first food compartments 130, 230, 330, and/or 430 described herein. In some embodiments, for example, the first food compartment can be a flexible pouch, bag, container, and/or the like. In some embodiments, the first food compartment can be at least partially evacuated of air (e.g., vacuum sealed). Moreover, in some embodiments, the first food compartment is configured to fluidically isolate the first food item contained therein for a volume of fluid contained in the first portion of the fluid immersion device.

Data associated with the first food item is provided to the fluid immersion device when the first food compartment is disposed in the first portion, at 92. For example, in some embodiments, the first food compartment can include an identifier (e.g., a physical identifier, a visual identifier, an electric and/or electronic identifier, and/or the like). In some embodiments, such an identifier, for example, can be a radio frequency identification (RFID) tag and/or the like. In this manner, when the first food compartment is disposed in the first portion, the fluid immersion device can detect, sense, read, engage, identify, and/or otherwise communicate with the identifier of the first food compartment. In some instances, the data associated with the first food item can include, for example, the type of food, storage instructions, cooking instructions, and/or any other suitable data and/or information. For example, in some embodiments, the first food item is a protein such as steak. In such embodiments, the data associated with the first food item can include, for example, information identifying the food item as steak, a weight and/or size of the steak, a storage temperature(s), a cooking temperature(s), a cooking duration, and/or any other suitable information.

A second food compartment containing a second food item is coupled to a carrier, at 93. The carrier can be any suitable shape, size, and/or configuration. For example, in some embodiments, the carrier can be substantially similar to the carrier 570 described above with reference to FIGS. 14 and 15. As such, the carrier can receive at least a portion of the second food compartment to temporarily couple the second food compartment thereto.

The second food compartment can be any suitable shape, size, and/or configuration. For example, in some embodiments, the second food compartment can be substantially similar to the second food compartment 135, 235, 335, 435, and/or 535 described in detail herein. In some embodiments, for example, the second food compartment can be a pouch, bag, container, and/or the like. In some embodiments, at least a portion of the second food compartment can be fluid permeable (e.g., can include a portion formed of a fluid permeable material, can define one or more holes, openings, apertures, etc., and/or can include one or more ports), as described in further detail herein. After coupling the second food compartment to the carrier, the carrier is disposed in the second portion of the fluid immersion device, at 94. In some embodiments, configuring at least a portion of the second food compartment to be fluid permeable can be such that the second food item is placed in contact with a fluid contained in the second portion of the fluid immersion device when the carrier (and thus, the second food compartment) is disposed therein the second portion of the fluid immersion device.

Data associated with the second food item is provided to the fluid immersion device when the carrier is posed in the second portion of the fluid immersion device, at 95. As described above with reference to the first food compartment, for example, the second food compartment can include an identifier and/or the like such as a RFID tag. In this manner, when the carrier and the second food compartment coupled thereto are disposed in the second portion, the fluid immersion device can detect, sense, read, engage, identify, and/or otherwise communicate with the identifier of the second food compartment. As described above, the data can include, for example, the type of food, storage instructions, cooking instructions, and/or any other suitable data and/or information. For example, in some embodiments, the second food item can be a starch such as rice. In such embodiments, the data associated with the second food item can include information identifying the food as rice, a quantity and/or weight of the rice, storage temperature(s), cooking temperature(s), cooking duration, and/or the like. Accordingly, the method 90 can be used to provide food items for use in a fluid immersion device.

Although not shown in FIG. 16, in some embodiments, a method for providing food items for use in a fluid immersion device can include providing more than two food items as described above with reference to the method 90. For example, in some embodiments, the method 90 can optionally include coupling a third food compartment containing a third food item to the carrier prior to disposing the carrier in the second portion of the fluid immersion. In some embodiments, the method 90 can further include coupling a fourth food compartment containing a fourth food item to the carrier prior to disposing the carrier in the second portion of the fluid immersion device. In some such embodiments, the third food compartment and the fourth food compartment can be substantially similar, for example, to the third food compartment 550 and the fourth food compartment 560, respectively, described above with reference to FIGS. 14 and 15. Furthermore, in such embodiments, after coupling the second, third, and fourth food compartments to the carrier, the carrier can be disposed in the second portion of the fluid immersion device (as described at 94, for example) and when the carrier is disposed therein, data associated with the third food item and data associated with the fourth food item can be provided to the fluid immersion device, as described above with reference to the data associated with the second food item (e.g., at 95). Thus, in some instances, the method 90 can be used to provide any suitable number of food items for use in a fluid immersion device such as those described herein.

In some embodiments, a user can, for example, subscribe to a meal delivery service in which the user selects the food items he or she wishes to eat (e.g., via a personal computer (PC) application, mobile application, web browser and the Internet, telephone service, etc.) and receives, via delivery, a cartridge such as those described herein containing the ordered food items. In this manner, the user can receive the food items and can place them within a storage and cooking device such as the device 10 without having to place the food items, for example, in freeze storage or the like. Such subscription services can be based on, for example, a desired number of meals per week and/or any other suitable measure. In other instances, a user can purchase one or more cartridges “on demand.” For example, a user can enter an order via the Internet and a web browser, PC or mobile application, etc.

While various embodiments have been described above, it should be understood that they have been presented by way of example only, and not limitation. Where schematics and/or embodiments described above indicate certain components arranged in certain orientations, positions, and/or configurations, the arrangement of components may be modified. Although various embodiments have been described as having particular features and/or combinations of components, other embodiments are possible having a combination of any features and/or components from any of embodiments as discussed above. For example, while the first food compartment 230 of the cartridge 200 is described above as being formed of a fluid impermeable material such that the inner volume 232 of the first food compartment 230 is fluidically isolated form the device 10 and the second food compartment 235 of the cartridge 200 is described above as including and/or defining the ports 244 configured to establish fluid communication between the inner volume 237 of the second food compartment 235 and the device 10, in other embodiments, a cartridge can include food compartments in any suitable arrangement and/or combination.

For example, in some embodiments, a first food compartment (e.g., containing a meat or protein) can include and/or can define one or more ports configured to establish fluid communication between a device and an inner volume of the first food compartment. Conversely, in some embodiments, a second food compartment (e.g., containing a starch and/or vegetable) need not include and/or define one or more ports and thus, the inner volume of the second food compartment can be fluidically isolated from the device. In any such arrangement and/or combination(s) thereof, the device can be configured to transfer thermal energy to the food items contained in the cartridge in any suitable manner (such as those described herein) to cook the food items contained in the cartridge.

While the embodiments have been particularly shown and described, it will be understood that various changes in form and details may be made. For example, while the cartridge 200 is described above as including the first food compartment 230 configured to receive a meat or other protein and a second food compartment 235 configured to receive a starch (e.g., in the first portion 238 of the inner volume 237) and a vegetable (e.g., in the second portion 239 of the inner volume 237), in other embodiments, a cartridge can have any suitable number of food compartments configured to receive any suitable food item. For example, in some embodiments, a cartridge can include a single food compartment configured to contain one of a meat, starch, or vegetable. In other embodiments, a cartridge can include a single food compartment configured to contain an entire meal including a meat, starch, and vegetable. In still other embodiments, a cartridge and/or cartridge assembly can include multiple food compartments configured to contain one or more food items. For example, in some embodiments, a cartridge or cartridge assembly can include two food compartments (e.g., the cartridges 200 and 300), three food compartments (e.g., the cartridge assembly 400), or more than three food compartments (e.g., four, five, or more compartments).

By way of another example, while the frame 210 is shown and described above as including the first member 211 and the second member 216 that are coupled to form the frame 210, in other embodiments, a frame of a cartridge can be formed from a single component, two components, or more than two components. Similarly, while the food compartments 230 and 235 are shown as being disposed between the first member 211 and the second member 216 to be coupled to the frame 210, in other embodiments, a cartridge can include a frame coupled to any number of food compartments in any suitable manner. For example, in some embodiments, the frame can be monolithically constructed and unitarily formed with, for example, at least one food compartment. Specifically, in some embodiments, the frame 210 can be monolithically constructed and unitarily formed with, for example, the second food compartment 235 (e.g., via injection molding or the like). In such embodiments, the first food compartment 230 can be coupled to the frame 210 in any suitable manner such as, for example, an adhesive, ultrasonic welding, one or more mechanical fasteners, etc.

The embodiments described herein can be packaged and/or manufactured in any suitable manner. For example, in some embodiments, disposing the starch and/or vegetable in a fluid permeable pouch or the like can reduce manufacturing time and/or complexity otherwise resulting from handling a loose food items (e.g., rice). In some such embodiments, the food items can be pre-packaged and placed in, for example, the second food compartment. Moreover, in some instances, disposing the starch and/or vegetable in a fluid permeable pouch or the like can simplify the removal of the cooked food from the cartridge.

While the embodiments, described herein have been described as being formed of a given material via a given manufacturing process, in other embodiments, any of the cartridges and/or portions of the cartridges described herein can be formed from any suitable material and/or formed via any suitable manufacturing process. For example, as described above with reference to the cartridge 200, a cartridge can be formed of a plastic or the like via injection molding or the like. In some embodiments, such cartridges and/or at least a portion of such cartridges can be disposable after cooking the food items contained therein. In other embodiments, however, at least a portion of a cartridge can be formed from any suitable material and configured for reuse. For example, in some embodiments, the frame 210 and the second compartment 235 of the cartridge 200 can be formed of a reusable material such as metal or plastic that can be cleaned after cooking food items contained therein (e.g., via the dishwasher or the like) and reused. Conversely, the first food compartment 230 can be temporarily coupled to the frame 210 and configured to be fungible. In such embodiments, the first food compartment 230 can be removed or decoupled from the frame 210 and discarded after food items contained therein have been cooked. In such embodiments, after cleaning the frame 210 and the second food compartment 235, uncooked food items can be inserted into the second food compartment 235 and a fresh first food compartment containing an uncooked food item can be at least temporarily coupled to the frame 210. Thus, the cartridge 200 can be “reloaded” and/or otherwise at least partially reusable.

Where methods and/or schematics described above indicate certain events and/or flow patterns occurring in certain order, the ordering of certain events and/or flow patterns may be modified. Additionally certain events may be performed concurrently in parallel processes when possible, as well as performed sequentially. For example, in some instances, the arrangement of the device 10 and the cartridge 200 can be such that the food items contained in the first food compartment 230 are cooked prior to and independent of the food items in the second food compartment 235. In other instances, the food items contained in the first food compartment 230 can be cooked in an at least partially concurrent process with the food items contained in the second food compartment 235.

1. A system for at least one of storing food items or cooking food items in a fluid immersion device, the system comprising:
a first food compartment configured to be disposed in a first portion of the fluid immersion device, the first food compartment having a set of walls defining an inner volume configured to receive a first food item, the walls configured to 1) fluidically isolate the first food item in the inner volume and 2) transfer thermal energy between a volume of fluid in the first portion of the fluid immersion device and the first food item;
a second food compartment configured to be disposed in a second portion of the fluid immersion device, the second food compartment having a set of walls defining an inner volume configured to receive a second food item, at least a portion of the walls being fluid permeable and configured to receive a flow of fluid flowing through the second portion of the fluid immersion device operable in transferring thermal energy from the fluid to the second food item; and
a carrier configured to be disposed in the second portion of the fluid immersion device, the carrier having a coupling portion configured to receive the second food compartment to at least temporarily couple the second food compartment to the carrier.

2. The system of claim 1, wherein the first food item is a protein.

3. The system of claim 1, wherein the second food item is at least one of a starch or a vegetable.

4. The system of claim 1, wherein the walls of the first food compartment form a flexible pouch.

5. The system of claim 1, wherein the first food compartment includes an absorbent member disposed in the inner volume of the first food compartment and configured to absorb fluid released by the first food item.

6. The system of claim 1, wherein the first food compartment includes an identifier associated with the first food item and configured to be detected by the fluid immersion device when the first food compartment is disposed in the first portion of the fluid immersion device.

7. The system of claim 6, wherein the second food compartment includes an identifier associated with the second food item and configured to be detected by the fluid immersion device when the second food compartment is disposed in the second portion of the fluid immersion device.

8. The system of claim 7, wherein each of the identifier of the first food compartment and the identifier of the second food compartment is a radio frequency identification tag.

9. The system of claim 1, wherein the second food compartment includes a cover removably coupled to the walls.

10. The system of claim 9, wherein the cover includes a tab, the second food compartment includes an identifier disposed in the tab.

11. The system of claim 10, wherein a size of the second food compartment is sufficiently large to substantially prevent the second food compartment from being disposed in the first portion of the fluid immersion device.

12. The system of claim 1, further comprising:
a third food compartment configured to contain a third food item, the third food compartment configured to be disposed in the second portion of the fluid immersion device to allow thermal energy to be transferred between the second portion of the fluid immersion device and the third food item.

13. The system of claim 1, further comprising:
a third food compartment configured to contain a third food item, the third food compartment configured to at least temporarily couple to the coupling portion of the carrier.

14. A system for at least one of storing food items or cooking food items in a fluid immersion device, the system comprising
a first food compartment configured to receive a first food item and to fluidically isolate the first food item therein, the first food compartment including an identifier associated with the first food item, the first food compartment configured to be disposed in a first portion of the fluid immersion device to allow thermal energy to be transferred between the first food item and a volume of fluid in the first portion of the fluid immersion device;
a second food compartment configured to receive a second food item and including an identifier associated with the second food item, the second food compartment configured to be disposed in a second portion of the fluid immersion device, at least a portion of the second food compartment being fluid permeable and configured to receive a volume of fluid from the second portion of the fluid immersion device operable in transferring thermal energy from the fluid to the second food item; and
a third food compartment configured to receive a third food item and including an identifier associated with the third food item, the third food compartment configured to be disposed in the second portion of the fluid immersion device, at least a portion of the third food compartment being fluid permeable and configured to receive a volume of fluid from the second portion of the fluid immersion device operable in transferring thermal energy from the fluid to the third food item.

15. The system of claim 14, further comprising:
a fourth food compartment configured to receive a fourth food item and to fluidically isolate the fourth food item therein, the fourth food item configured to be disposed in the second portion of the fluid immersion device to allow thermal energy to be transferred between the first food item and the fluid in the second portion of the fluid immersion device.

16. The system of claim 16, wherein the fourth food compartment includes an identifier associated with the fourth food item.

17. The system of claim 15, further comprising:
a carrier having a coupling portion configured to at least temporarily couple the second food compartment, the third food compartment, and the fourth food compartment to the carrier.

18. The system of claim 14, wherein the second food compartment includes a cover removably coupled to the walls, the cover having a tab including the identifier associated with the second food item, and
the third food compartment includes a cover removably coupled to the walls, the cover having a tab including the identifier associated with the third food item.

19. The system of claim 18, further comprising:
a fourth food compartment configured to receive a third food item and to be disposed in the second portion of the fluid immersion device,
the fourth food compartment includes a cover removably coupled to the walls, the cover having a tab including an identifier associated with the fourth food item.

20. The system of claim 14, wherein the second food compartment has a first size and the third food compartment has a second size, the first size and the second size based at least in part on a size of the second portion of the fluid immersion device.

21.-30. (canceled)
